(19) United States
(12) Patent Application Publication
(10) Pub. No.: US 2015/0322218 A1
(43) Pub. Date: Nov. 12, 2015

(54) POLYIMIDE FILMS AND PRODUCTION METHODS THEREOF

(71) Applicant: SAMSUNG ELECTRONICS CO., LTD., Suwon-si (KR)

(72) Inventors: Sung Won CHOI, Hwaseong-si (KR); Chan Jae Ahn, Seoul (KR); Sung Woo Hong, Seoul (KR); Won Suk CHANG, Hwaseong-si (KR); A Ra JO, Anyang-si (KR)

(21) Appl. No.: 14/625,035

(22) Filed: Feb. 18, 2015

(30) Foreign Application Priority Data
May 9, 2014 (KR) 10-2014-0055667

(51) Int. Cl. C08J 5/18

(52) U.S. Cl. CPC C08J 5/18; C08J 2379/08

(57) ABSTRACT

A method of producing a polyimide film, including obtaining a polyamic acid including a repeating unit of Chemical Formula 1:
Chemical Formula 1

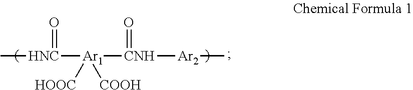

wherein Ar₁ and Ar₂ are described in the specification;
imidizing the polyamic acid to obtain a partially imidized polyimide;
determining a sub-Tg temperature of the partially imidized polyimide; and
heating the partially imidized polyimide in at least two steps to obtain a polyimide film, wherein a step transition temperature range is within the sub-Tg temperature±30° C.

### CROSS-REFERENCE TO RELATED APPLICATION

This application claims priority to Korean Patent Application No. 10-2014-0055667, filed on May 9, 2014, and all the benefits accruing therefrom under 35 U.S.C. §119, the content of which is incorporated herein in its entirety by reference.

### BACKGROUND

1. Field

This disclosure relates to polyimide films and production methods thereof.

2. Description of the Related Art

Currently available flat panel displays may be classified into emitting display devices that emit light by themselves and non-emitting display devices that require a separate light source. Optical compensation films such as phase difference films are often used for improving image quality of the flat panel displays.

In an emitting display device, for example, an organic light emitting display, visibility and contrast ratio may be decreased due to reflection of external light by a metal such as an electrode in the display device. In order to reduce image deterioration, a phase difference film may be used to prevent the external light reflected in the display device from leaking out of the display device. In a liquid crystal display (“LCD”), which is a kind of non-emitting display device, elliptical polarization may occur due to birefringence of liquid crystal and crossed polarizing plates in the display device, which may cause a decreased contrast ratio. Optical compensation films may change elliptical polarization into circular polarization to enhance picture quality. As for the liquid crystal display, the device may become thicker due to the thickness of the liquid crystal. Therefore, out-of-plane retardation (i.e., the retardation in a thickness direction, hereinafter “Rₜₕ”) may have greater impact on the image quality than in-plane retardation (hereinafter “Rₑ”). As the out-of-plane retardation increases, light leakage may occur, which may lead to a decrease in the viewing angle and contrast ratio. Therefore, in order to realize a high definition display, small out-of-plane retardation of the substrate may be desired.

Meanwhile, a need for a flexible display, which is thin and light as paper, which requires a low amount of electric power, and which can be carried without being limited to place or time, is increasing. In order to realize the flexible display, a substrate for the flexible display, an organic or inorganic material to be processed, flexible electronics, encapsulating and packaging technology, etc., are strongly desired. Among them, the flexible substrate may be the most important material defining performance, reliability, and price of the flexible display.

Various polymers have been suggested for use as the flexible substrate or the compensation films. Polymers are light materials, which may be easily processed into a film. However, many polymers have poor heat stability, and thus, to be used as flexible substrates and compensation films, the thermal properties of the polymers need to be enhanced.

Accordingly, it is still desirable to develop a transparent polymer film having short (out of plane) retardation and excellent thermal stability.

### SUMMARY

An embodiment provides methods of producing polyimide films having enhanced thermal properties and optical properties.

Another embodiment provides polyimide films produced thereby.

Another embodiment provides electronic devices including the polyimide films.

According to an embodiment, a method of producing a polyimide film is provided, including:

obtaining a polyamic acid including a repeating unit of Chemical Formula 1:

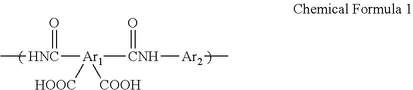

wherein Ar₁ is a moiety selected from a substituted or unsubstituted tetravalent C5 to C24 aliphatic cyclic group, a substituted or unsubstituted tetravalent C6 to C24 aromatic cyclic group, and a substituted or unsubstituted tetravalent C6 to C24 heteroaromatic cyclic group, wherein the aliphatic cyclic group, the aromatic cyclic group, or heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof,

Ar₂ is a moiety selected from a substituted or unsubstituted divalent C5 to C24 aliphatic cyclic group, a substituted or unsubstituted divalent C6 to C24 aromatic cyclic group, and a substituted or unsubstituted divalent C4 to C24 heteroaromatic cyclic group, and -L-SiR₂—O—SiR₂-L- (wherein L is a single bond or a C1 to C10 alkylene group), wherein the aliphatic cyclic group, the aromatic cyclic group, or the heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 divalent alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof, and

wherein at least one of Ar₁ and Ar₂ includes an aromatic or aliphatic ring substituted with a C1 to C10 fluoroalkyl group, two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group, or a combination thereof;

imidizing the polyamic acid to obtain a partially imidized polyimide;
determining a sub-Tg temperature of the partially imidized polyimide; and

heating the partially imidized polyimide in at least two steps to obtain a polyimide film, wherein a step transition temperature range includes a temperature within the sub-Tg temperature±30° C.

Ar₁ may be selected from groups:

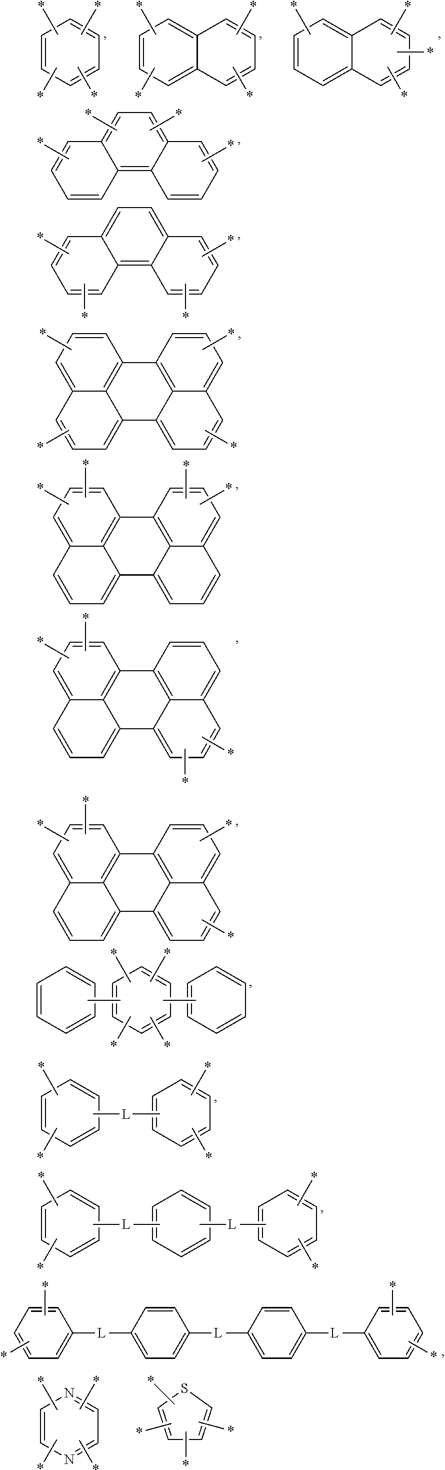

In the groups, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—, and an aromatic ring in the groups is not substituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and

* indicates a binding site to a carbon atom of the carbonyl in an imide ring.

Ar₂ may be selected from groups:

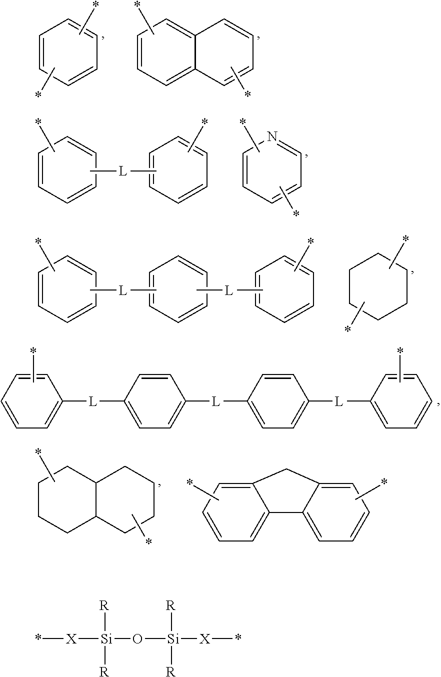

In the groups, linkers L are is the same or different and are each independently, a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—, and

linkers X are the same or different and are each independently a substituted or unsubstituted C1 to C10 alkylene group, a substituted or unsubstituted C4 to C20 cycloalkylene group, or a substituted or unsubstituted C6 to C20 arylene group, and

an aromatic or alicyclic ring in the groups is not substituted or at least one hydrogen of the aromatic or alicyclic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and

* indicates a binding site to a nitrogen atom of an imide ring.

Ar₁ may be represented by chemical formula:

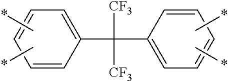

wherein * indicates a binding site to a carbon atom of the carbonyl in an imide ring, each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

Ar₂ may be represented by chemical formula:

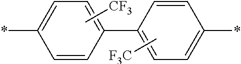

wherein * indicates a binding site to a nitrogen atom of an imide ring, each aromatic ring is unsubstituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

The imidization is carried out by chemical imidization.

The partially imidized polyimide may have a degree of imidization of less than 100%.

The determining of the sub-Tg temperature of the partially imidized polyimide includes preparing the partially imidized polyimide as a film containing about at least 10 percent (%) by weight of a residual solvent, and determining a temperature of the first tan δ peak of a curve in a temperature sweep obtained from a dynamic mechanical analysis of the film at a predetermined frequency.

The sub-Tg temperature of the partially imidized polyimide may be within a range of about 100° C. to about 250° C.

The polyimide film may have birefringence (Δn) of less than or equal to about 0.025 as defined by Equation 1:

Δn=(nₓ+n_{y})/2−n_{z} Equation 1

wherein nₓ and n_{y} are in-plane refractivities and n_{z} is out-of-plane refractivity.

The polyimide film may have a 0.5 percent by weight (wt %) loss decomposition temperature of greater than or equal to about 460° C. in a thermogravimetric analysis.

In another embodiment, a polyimide film includes a repeating unit represented by Chemical Formula 2, and its birefringence (Δn) defined by Equation 1 is less than or equal to about 0.025 and its 0.5 wt % loss decomposition temperature is greater than or equal to about 420° C. in a thermogravimetric analysis:

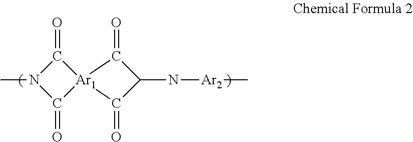

wherein Ar₁ is a moiety selected from a substituted or unsubstituted tetravalent C5 to C24 aliphatic cyclic group, a substituted or unsubstituted tetravalent C6 to C24 aromatic cyclic group, and a substituted or unsubstituted tetravalent C6 to C24 heteroaromatic cyclic group, wherein the aliphatic cyclic group, the aromatic cyclic group, or the heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof,

Ar₂ is a moiety selected from a substituted or unsubstituted divalent C5 to C24 aliphatic cyclic group, a substituted or unsubstituted divalent C6 to C24 aromatic cyclic group, and a substituted or unsubstituted divalent C4 to C24 heteroaromatic cyclic group, and -L-SiR₂—O—SiR₂-L- (wherein L is a single bond or a C1 to C10 alkylene group), wherein the aliphatic cyclic group, the aromatic cyclic group, or the heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 divalent alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof, and

wherein at least one of Ar₁ and Ar₂ includes an aromatic or aliphatic ring substituted with a C1 to C10 fluoroalkyl group, two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group, or a combination thereof.

Ar₂ may be selected from groups.

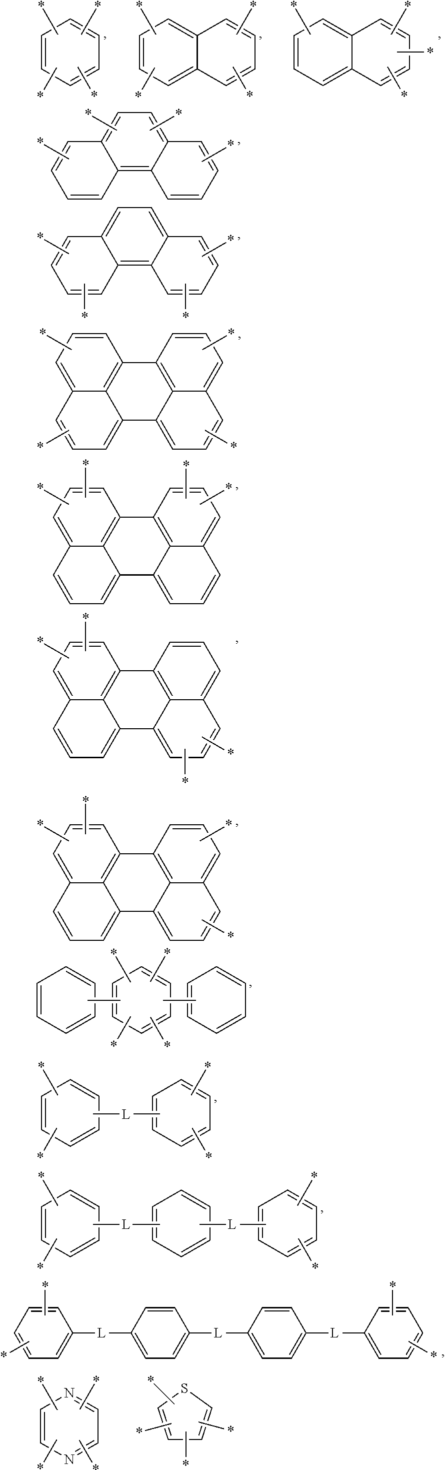

In the groups, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two R are not simultaneously hydrogen), —C(CF₃)₂—, —C(CF₃)(C₆H₅)—, or —C(═O)NH—, and

an aromatic ring in the groups is not substituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and

* indicates a binding site to a carbon atom of the carbonyl in an imide ring.

Ar₂ may be selected from groups.

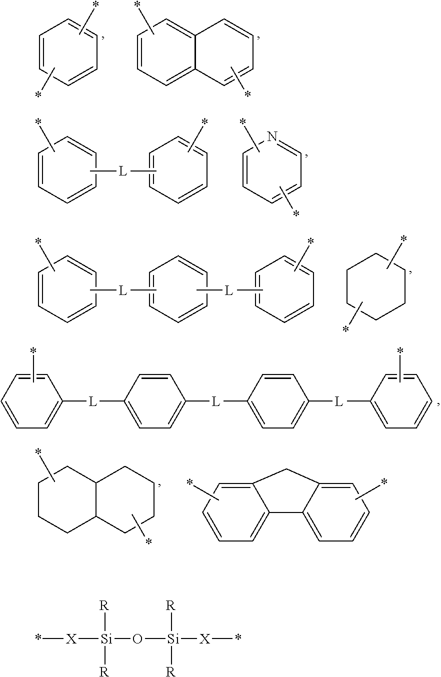

In the groups, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—, and

linkers X are the same or different and are each independently a substituted or unsubstituted C1 to C10 alkylene group, a substituted or unsubstituted C4 to C20 cycloalkylene group, or a substituted or unsubstituted C6 to C20 arylene group, and

an aromatic or alicyclic ring in the groups is not substituted or at least one hydrogen of the aromatic or alicyclic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and

* indicates a binding site to a nitrogen atom of an imide ring.

Ar₁ may be represented by chemical formula:

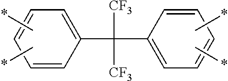

wherein * indicates a binding site to a carbon atom of the carbonyl in an imide ring, each aromatic ring is unsubstituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

Ar₂ may be represented by chemical formula:

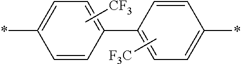

wherein * indicates a binding site to a nitrogen atom of an imide ring, each aromatic ring is unsubstituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

The film may have transmittance of greater than or equal to about 70% with respect to light having a wavelength of 430 nanometers (nm).

The film may have birefringence (Δn) defined by Equation 1 of less than or equal to about 0.005, and show a 0.5 wt % loss decomposition temperature of greater than or equal to about 460° C. in a thermogravimetric analysis.

The polyimide is a co-polyimide having at least two different repeating units, wherein the repeating units are represented by Chemical Formula 2 and are different from each other in Ar₁, Ar₂, or both.

In another embodiment, an electronic device including the foregoing polyimide film is provided.

The electronic device may be a flat panel display, a touch screen panel, a photovoltaic cell, an e-window, a heat mirror, a transparent transistor, a flexible display, a complementary metal-oxide semiconductor, or light emitting diode lighting.

The polyimide film thus obtained may have excellent thermal stability together with a significantly reduced value of out-of-plane retardation.

### BRIEF DESCRIPTION OF THE DRAWINGS

The above and other aspects, advantages, and features of this disclosure will become more apparent by describing exemplary embodiments thereof in further detail with reference to the accompanying drawings, in which:

FIG. 1 is a graph of Tan Delta versus temperature (degrees Centigrade, ° C.) showing the results of dynamic mechanical analysis;

FIG. 2 is a graph of out-of-plane retardation Rₜₕ (nanometers, nm) versus temperature (degrees Centigrade, ° C.), which is a view showing the out-of-plane retardation of the polyimide films prepared at different heat-treating temperatures in the examples;

FIG. 3 is a graph of out-of-plane retardation Rₜₕ (nanometers, nm) versus temperature (degrees Centigrade, ° C.) showing changes in the out-of-plane retardation (Rₜₕ) over the changes in the heat treating manners and the temperatures;

FIG. 4 is a graph of percent decrease in out-of-plane retardation Rₜₕ versus temperature (degrees Centigrade, ° C.) showing changes in the out-of-plane retardation (Rₜₕ) over the changes in the heat treating manners and the temperatures; and

FIG. 5 is a graph of percent by weight versus temperature (degrees Centigrade, ° C.) showing the results of the thermogravimetric analysis for the polyimide film of Example 1.

### DETAILED DESCRIPTION

This disclosure will be described more fully hereinafter with reference to the accompanying drawings, in which embodiments are shown. This disclosure may, however, be embodied in many different forms and is not to be construed as limited to the exemplary embodiments set forth herein. Accordingly, the exemplary embodiments are merely described below, by referring to the figures, to explain aspects of the present inventive concept.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing present embodiments only and is not intended to be limiting. As used herein, the singular forms “a,” “an,” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, when a specific definition is not otherwise provided, the term “substituted” refers to a group or compound substituted with at least one substituent including a halogen (—F, —Br, —Cl, or —I), a hydroxyl group, a nitro group, a cyano group, an amino group, an amidino group, a hydrazine group, a hydrazone group, a carboxyl group, an ester group, a ketone group, a substituted or unsubstituted alkyl group, a substituted or unsubstituted alicyclic organic group, a substituted or unsubstituted aryl group, a substituted or unsubstituted alkenyl group, a substituted or unsubstituted alkynyl group, a substituted or unsubstituted heteroaryl group, and a substituted or unsubstituted heterocyclic group, in place of at least one hydrogen of a functional group, or the substituents may be linked to each other to provide a ring.

As used herein, the term “alkyl group” refers to a group derived from a straight or branched chain saturated aliphatic hydrocarbon having the specified number of carbon atoms and having a valence of at least one. Non-limiting examples of the alkyl group are methyl, ethyl, and propyl.

As used herein, the term “fluoroalkyl group” refers to an alkyl group as defined above, wherein one or more hydrogen atoms are substituted with a fluorine atom. Non-limiting examples of the fluoroalkyl group are fluoromethyl, 2-fluoroethyl, and 3-fluoropropyl.

As used herein, the term “alkoxy group” refers to “alkyl-O-”, wherein the term “alkyl” has the same meaning as described above. Non-limiting examples of the alkoxy group are methoxy, ethoxy, propoxy, cyclopropoxy, and cyclohexyloxy.

As used herein, the term “cycloalkyl group” refers to a monovalent group having one or more saturated rings in which all ring members are carbon. Non-limiting examples of the cycloalkyl group are cyclopentyl and cyclohexyl.

As used herein, the term “aliphatic cyclic group” refers to a group derived from an aliphatic cyclic (alicyclic)_hydrocarbon. Non-limiting examples of the aliphatic cyclic group are 2-methylcyclohexyl and 2-cyclopentylethyl.

As used herein, the term “aromatic cyclic group” refers to a group including at least one aromatic ring, in which all ring members are carbon. Non-limiting examples of the aromatic cyclic group are phenyl and naphthyl.

As used herein, the term “heteroaromatic cyclic group” refers to a group including one, two, or three heteroatom(s) selected from O, S, N, P, Si, and a combination thereof in an aromatic ring. Non-limiting examples of the heteroaromatic cyclic group include pyridine, thiophene, and pyrazine.

As used herein, the term “aromatic hydrocarbyl group” refers to a monovalent group derived from an aromatic hydrocarbon. Non-limiting examples of the aromatic hydrocarbyl group are phenyl and naphthyl.

As used herein, the term “alicyclic hydrocarbyl group” refers to a monovalent group derived from an alicyclic hydrocarbon. Non-limiting examples of the alicyclic hydrocarbyl group are cyclohexylmethyl, 3-propylcyclopentyl, and 3-methyl cyclobutyl.

As used herein, when a specific definition is not otherwise provided, the term “alkyl group” refers to a C1 to C30 alkyl group, for example a C1 to C15 alkyl group, the term “fluoroalkyl group” refers to a C1 to C30 fluoroalkyl group, the term “cycloalkyl group” refers to a C3 to C30 cycloalkyl group, for example a C3 to C18 cycloalkyl group, the term “aryl group” refers to a C6 to C30 aryl group, for example a C6 to C18 aryl group.

As used herein, when a specific definition is not otherwise provided, the term “aliphatic” refers to a C1 to C30 alkyl group, a C2 to C30 alkenyl group, a C2 to C30 alkynyl group, a C1 to C30 alkylene group, a C2 to C30 alkenylene group, or a C2 to C30 alkynylene group, for example a C1 to C15 alkyl group, a C2 to C15 alkenyl group, a C2 to C15 alkynyl group, a C1 to C15 alkylene group, a C2 to C15 alkenylene group, or a C2 to C15 alkynylene group, the term “alicyclic group” refers to a C3 to C30 cycloalkyl group, a C3 to C30 cycloalkenyl group, a C3 to C30 cycloalkynyl group, a C3 to C30 cycloalkylene group, a C3 to C30 cycloalkenylene group, or a C3 to C30 cycloalkynylene group, for example a C3 to C15 cycloalkyl group, a C3 to C15 cycloalkenyl group, a C3 to C15 cycloalkynyl group, a C3 to C15 cycloalkylene group, a C3 to C15 cycloalkenylene group, or a C3 to C15 cycloalkynylene group.

In a method of producing a polyimide film according to an embodiment, a polyamic acid including a repeating unit of Chemical Formula 1 is obtained:

Chemical Formula 1

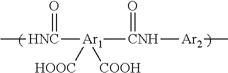

wherein Ar₁ is a moiety selected from a substituted or unsubstituted tetravalent C5 to C24 aliphatic cyclic group, a substituted or unsubstituted tetravalent C6 to C24 aromatic cyclic group, and a substituted or unsubstituted tetravalent C6 to C24 heteroaromatic cyclic group, wherein the aliphatic cyclic group, the aromatic cyclic group, or the heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof,

Ar₂ is a moiety selected from a substituted or unsubstituted divalent C5 to C24 aliphatic cyclic group, a substituted or unsubstituted divalent C6 to C24 aromatic cyclic group, and a substituted or unsubstituted divalent C4 to C24 heteroaromatic cyclic group, and -L-SiR₂—O—SiR₂-L- (wherein L is a single bond or a C1 to C10 alkylene group), wherein the aliphatic cyclic group, the aromatic cyclic group, or the heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 divalent alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof, and

wherein at least one of Ar₁ and Ar₂ includes an aromatic or aliphatic ring substituted with at least one C1 to C10 fluoroalkyl group, two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group, or a combination thereof.

For example, Ar₁ may be selected from the following groups:

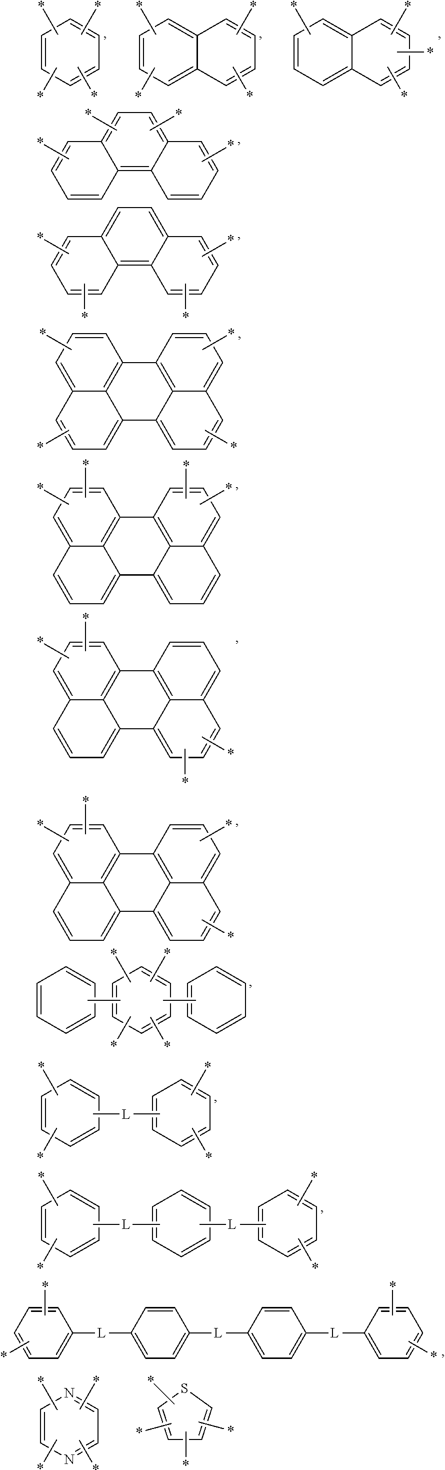

In the above groups, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—, and

an aromatic ring in the groups is not substituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and

* indicates a binding site to a carbon atom of the carbonyl in an imide ring.

In non-limiting examples, Ar₁ may be selected from the following, but is not limited thereto:

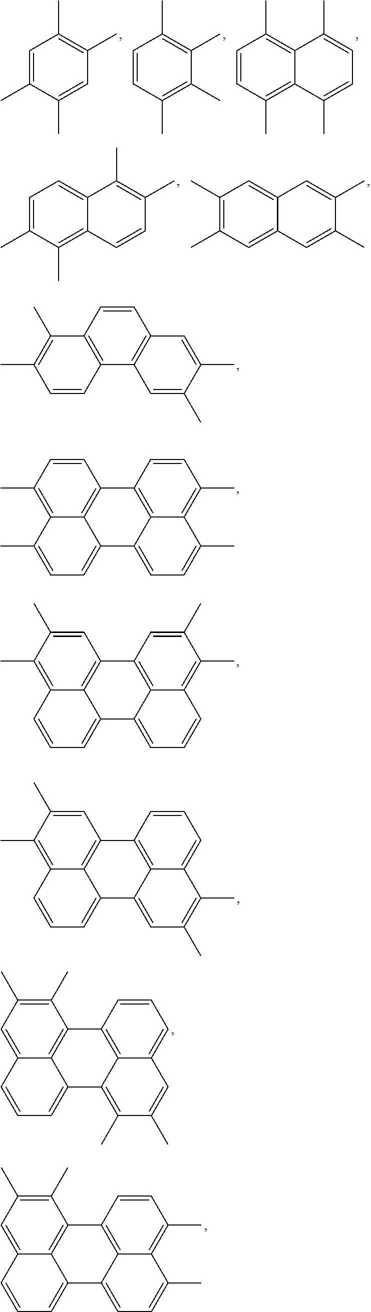

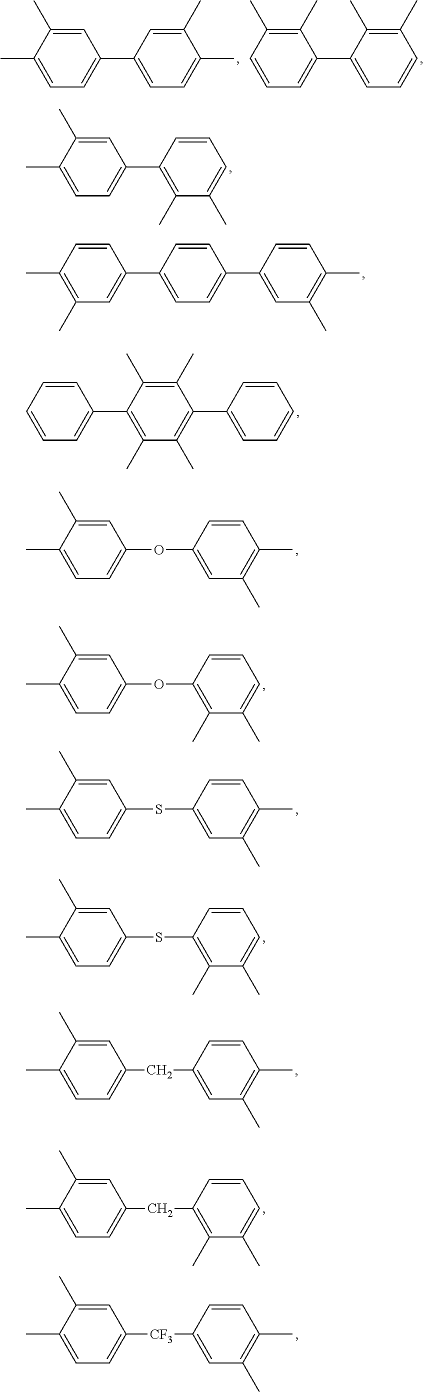

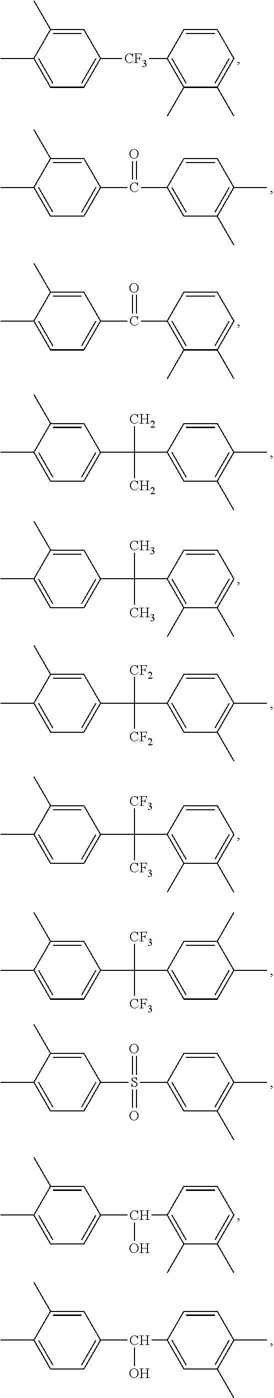

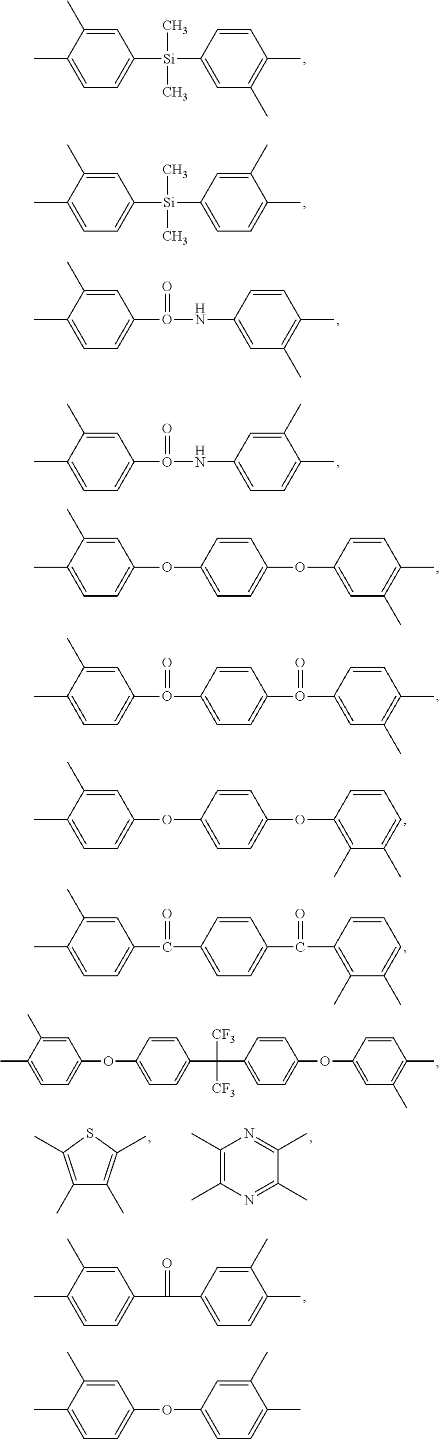

Ar₂ may be selected from the following groups:

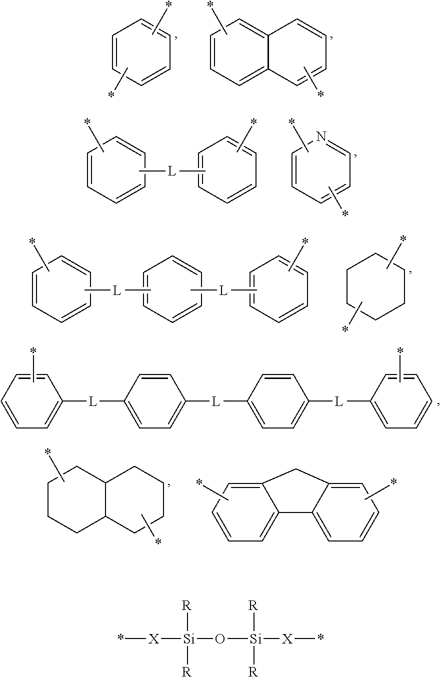

In the above groups, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—,

linkers X are the same or different and are each independently a substituted or unsubstituted C1 to C10 alkylene group, a substituted or unsubstituted C4 to C20 cycloalkylene group, or a substituted or unsubstituted C6 to C20 arylene group,

an aromatic or alicyclic ring in the groups is not substituted or at least one hydrogen of the aromatic or alicyclic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and

* indicates a binding site to a nitrogen atom of an imide ring.

Ar₂ may be selected from the following, but is not limited thereto:

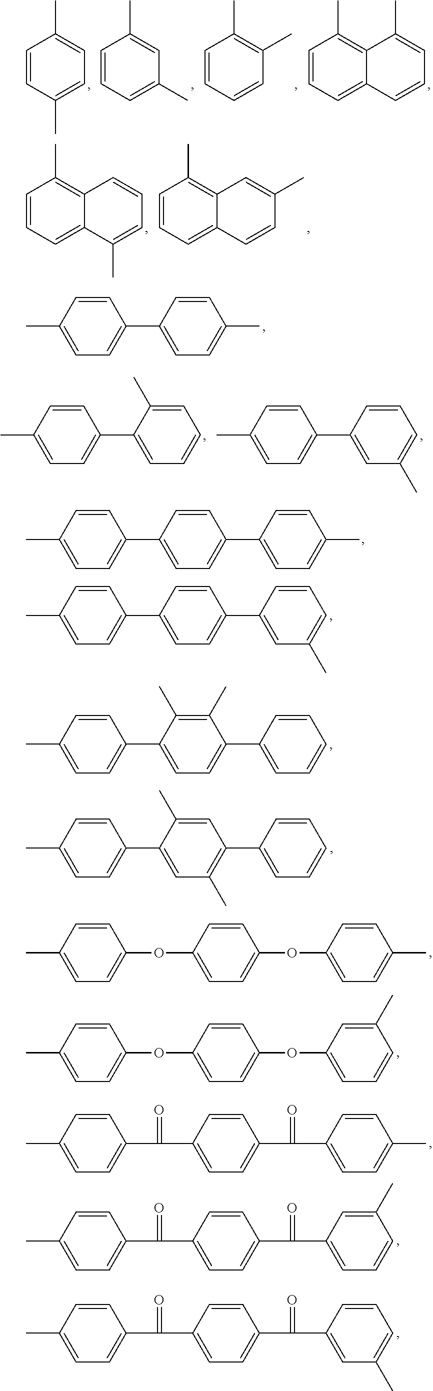

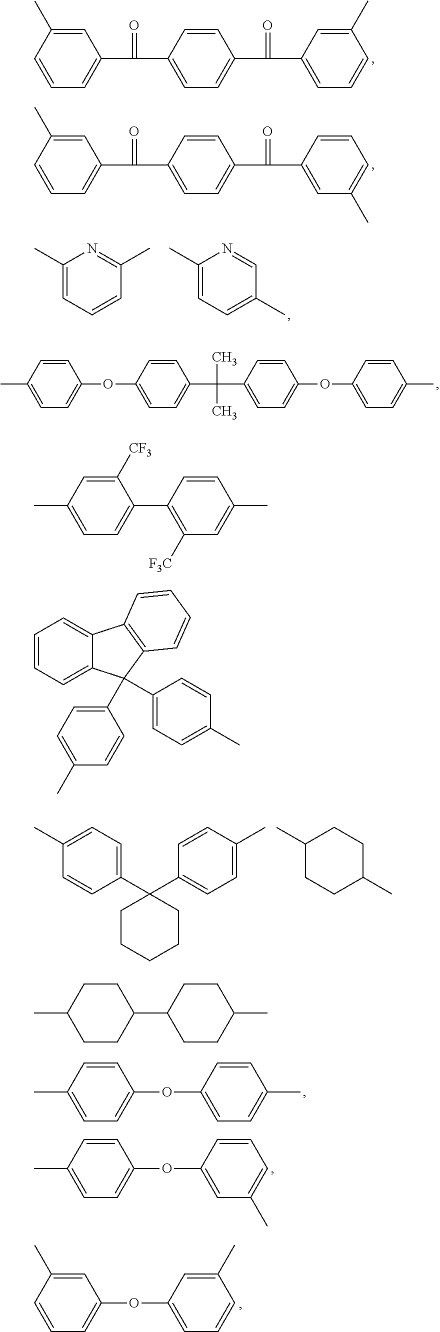

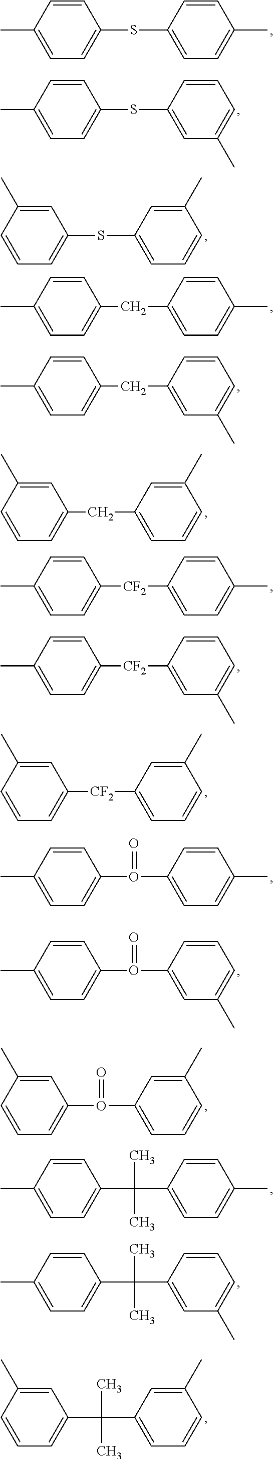

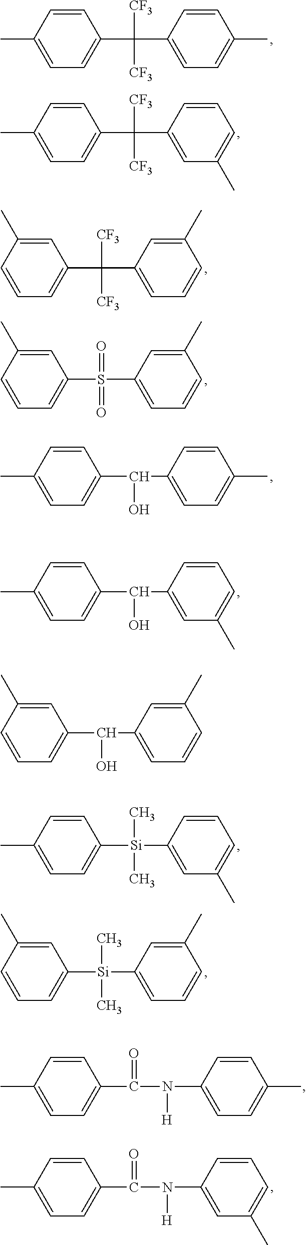

In Chemical Formula 1, at least one of Ar₁ and Ar₂ may have a moiety including a bulky side chain. In other words, in Chemical Formula 1, at least one of Ar₁ and Ar₂ may include: an aromatic or alicyclic ring (for example, phenylene, biphenylene, cyclohexylene, and the like) substituted with at least one C1 to C10 fluoroalkyl group (for example, a trifluoro methyl group and the like); two alicyclic or aromatic groups linked by a C1 to C10 alkylene having at least one moiety selected from a C1 to C10 straight or branched aliphatic hydrocarbon moiety (methyl, ethyl, propyl, isopropyl, and the like), a C1 to C10 fluoroalkyl moiety (trifluoromethyl group and the like), a C6 to C20 aromatic hydrocarbon moiety (benzyl, fluorenyl, and the like), and a C6 to C20 alicyclic hydrocarbon moiety (cyclohexyl and the like); or a combination thereof.

In the polyimide or the polyamic acid, the ratio of the repeating unit having the bulky side group may be greater than or equal to about 1%, for example, greater than or equal to about 5%, greater than or equal to about 10%, greater than or equal to about 20%, greater than or equal to about 30%, greater than or equal to about 40%, greater than or equal to about 50%, or greater than or equal to about 60%.

In an embodiment, Ar₁ may be represented by the following chemical formula:

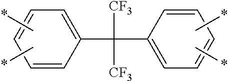

wherein * indicates a binding site to a carbon atom of the carbonyl in an imide ring, each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof. The amount of the Ar₁ being represented by the above chemical formula may be greater than or equal to about 1%, for example, greater than or equal to about 5%, greater than or equal to about 12%, or greater than or equal to about 20%, based on the total repeating units derived from the acid dianhydride in the polyimide.

In an embodiment, Ar₂ may be represented by the following chemical formula:

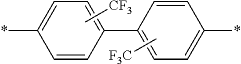

wherein * indicates a binding site to a nitrogen atom of an imide ring, each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof. The amount of the Ar₂ being represented by the above chemical formula may be greater than or equal to about 1%, for example, greater than or equal to about 5%, greater than or equal to about 10%, greater than or equal to about 25%, greater than or equal to about 50%, greater than or equal to about 75%, or 100%, based on the total repeating units derived from the acid dianhydride in the polyimide.

The aforementioned polyamic acid may be prepared by any known method or may be commercially available. For example, the polyamic acid may be prepared by a solution polymerization method. That is, the polyamic acid may be obtained by conducting condensation polymerization of an acid dianhydride monomer including Ar₁ and a diamine monomer including Ar₂ in a solvent.

Examples of the available acid dianhydride monomer may include, but are not limited to, 3,3′,4,4′-biphenyl tetracarboxylic dianhydride (BPDA); bicyclo[2.2.2]oct-7-ene-2,3,5,6-tetracarboxylic dianhydride (BTDA); 3,3′,4,4′-diphenylsulfone tetracarboxylic dianhydride (DSDA); 4,4′-(hexafluoroisopropylidene)diphthalic anhydride (6FDA); 4,4′-oxydiphthalic anhydride (ODPA); pyromellitic dianhydride (PMDA); 4-(2,5-dioxotetrahydrofuran-3-yl)-1,2,3,4-tetrahydronaphthalene-1,2-dicarboxylic anhydride (DTDA); 1,2,4,5-benzene tetracarboxylic acid dianhydride; 1,2,3,4-benzene tetracarboxylic acid dianhydride; 1,4-bis(2,3-dicarboxyphenoxy)benzene dianhydride; 1,3-bis(3,4-dicarboxyphenoxy)benzene dianhydride; 1,2,4,5-naphthalene tetracarboxylic acid dianhydride; 1,2,5,6-naphthalene tetracarboxylic acid dianhydride; 1,4,5,8-naphthalene tetracarboxylic acid dianhydride; 2,3,6,7-naphthalene tetracarboxylic acid dianhydride; 2,6-dichloronaphthalene-1,4,5,8-tetracarboxylic acid dianhydride; 2,7-dichloronaphthalene-1,4,5,8-tetracarboxylic acid dianhydride; 2,3,6,7-tetrachloronaphthalene-1,4,5,8-tetracarboxylic acid dianhydride; 2,2′,3,3′-diphenyl tetracarboxylic acid dianhydride; 4,4′-bis(3,4-dicarboxyphenoxy)diphenyl dianhydride; bis(2,3-dicarboxyphenyl)ether dianhydride; 4,4′-bis(2,3-dicarboxyphenoxy)diphenylether dianhydride; 4,4′-bis(3,4-dicarboxyphenoxy)diphenylether dianhydride; bis(3,4-dicarboxyphenyl)sulfide dianhydride; 4,4′-bis(2,3-dicarboxyphenoxy)diphenylsulfide dianhydride; 4,4′-bis(3,4-dicarboxyphenoxy)diphenylsulfide dianhydride; bis(3,4-dicarboxyphenyl)sulfone dianhydride; 4,4′-bis(2,3-dicarboxyphenoxy)diphenylsulfone dianhydride; 4,4′-bis(3,4-dicarboxyphenoxy)diphenylsulfone dianhydride; 3,3′,4,4′-benzophenone tetracarboxylic acid dianhydride; 2,2′,3,3′-benzophenone tetracarboxylic acid dianhydride; 2,3,3′4′-benzophenone tetracarboxylic acid dianhydride; 4,4′-bis(3,4-dicarboxyphenoxy)benzophenone dianhydride; bis(2,3-dicarboxyphenyl)methane dianhydride; bis(3,4-dicarboxyphenyl)methane dianhydride; 1,1-bis(2,3-dicarboxyphenyl)ethane dianhydride; 1,1-bis(3,4-dicarboxyphenyl)ethane dianhydride; 1,2-bis(3,4-dicarboxyphenyl)ethane dianhydride; 2,2-bis(2,3-dicarboxyphenyl)propane dianhydride; 2,2-bis(3,4-dicarboxyphenyl)propane dianhydride; 2,2-bis[4-(2,3-dicarboxyphenoxyl)phenyl]propane dianhydride; 2,2-bis[4-(3,4-dicarboxy phenoxy) phenyl]propane dianhydride; 4-(2,3-dicarboxyphenoxy)-4′-(3,4-dicarboxyphenoxyl)diphenyl-2,2-propane dianhydride; 2,2-bis[4-(3,4-dicarboxyphenoxy-3,5-dimethyl)phenyl]propane dianhydride; 2,3,4,5-thiophene tetracarboxylic acid dianhydride; 2,3,5,6-pyrazine tetracarboxylic acid dianhydride; 1,8,9,10-phenanthrene tetracarboxylic acid dianhydride; 3,4,9,10-perylene tetracarboxylic acid dianhydride; 1,3-bis(3,4-dicarboxyphenyl)hexafluoropropane dianhydride; 1,1-bis(3,4-dicarboxyphenyl)-1-phenyl-2,2,2-trifluoroethane dianhydride; 2,2-bis[4-(3,4-dicarboxyphenoxyl)phenyl]hexafluoropropane dianhydride; 1,1-bis[4-(3,4-dicarboxyphenoxyl)phenyl]-1-phenyl-2,2,2-trifluoroethane dianhydride; and 4,4′-bis[2-(3,4-dicarboxyphenyl)hexafluoroisopropyl]diphenylether dianhydride. The foregoing acid dianhydride monomers may be synthesized by any known method or may be commercially available.

The acid dianhydride monomer may be used alone or as a mixture of at least two monomers. For example, as the acid dianhydride monomer, a mixture of biphenyl tetracarboxylic acid dianhydride (BPDA) and 4,4′-(hexafluoroisopropylidene) diphthalic anhydride (6 FDA) may be used.

In an embodiment, the diamine may be at least one selected from the compounds represented by any of the following chemical formulae.

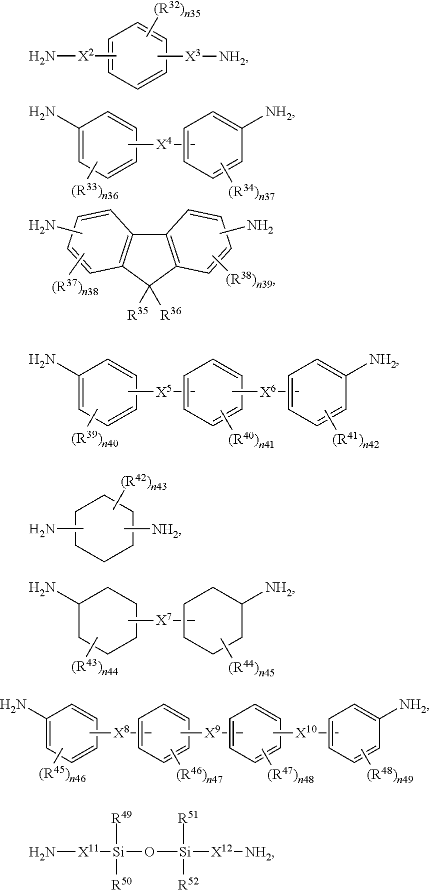

In the above chemical formulae,

R³² to R⁵² are the same or different and may each independently be hydrogen, a halogen, a nitro group, a substituted or unsubstituted C1 to C15 alkyl group, a substituted or unsubstituted C1 to C15 alkoxy group, a substituted or unsubstituted C1 to C15 fluoroalkyl group, a substituted or unsubstituted C3 to C15 cycloalkyl group, a substituted or unsubstituted C3 to C15 heterocycloalkyl group, a substituted or unsubstituted C3 to C15 cycloalkoxy group, a substituted or unsubstituted C6 to C15 aryl group, a substituted or unsubstituted C6 to C15 aryloxy group, or a substituted or unsubstituted C2 to C15 heteroaryl group,

X² to X¹² are the same or different and may each independently be a single bond, a substituted or unsubstituted C1 to C10 alkylene group, a substituted or unsubstituted C3 to C10 cycloalkylene group, a substituted or unsubstituted C5 to C40 heterocycloalkylene group, a substituted or unsubstituted C6 to C15 arylene group, a substituted or unsubstituted C3 to C40 heteroarylene group, —SO₂—, —O—, —C(═O)—, or a combination thereof,

n35 to n37 and n40 to n49 are integers ranging from 0 to 4, and

n38 and n39 are integers ranging from 0 to 3.

For example, the diamine monomer may be represented by any one of the following chemical formulae:

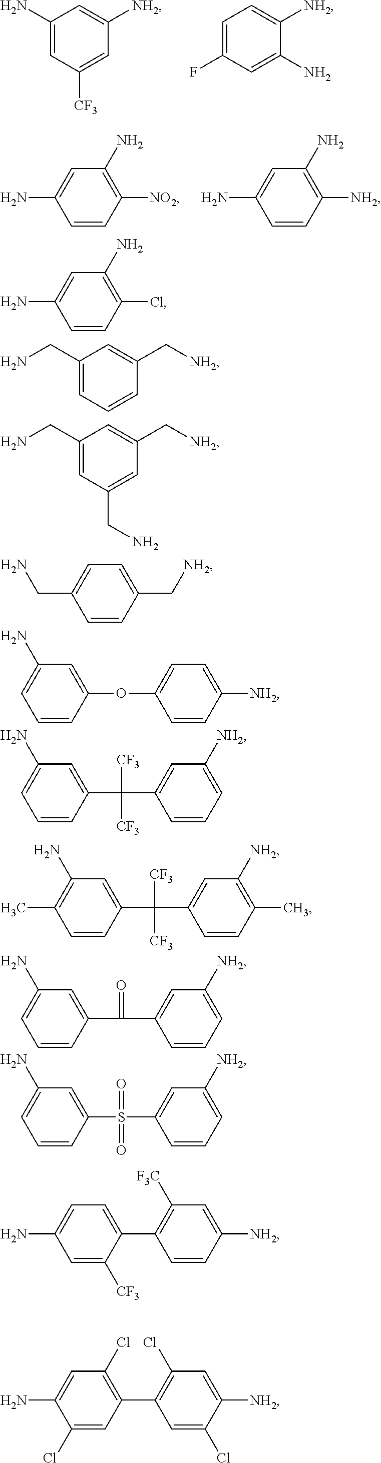

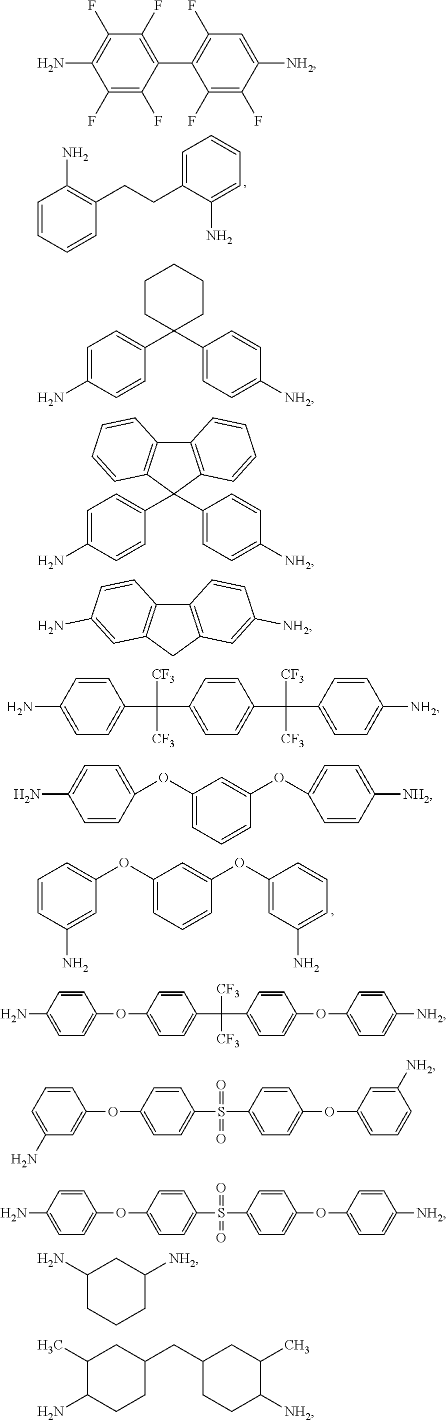

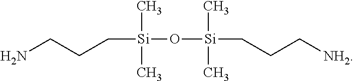

Examples of the available diamine monomer may include, but are not limited to, m-phenylene diamine; p-phenylene diamine; 1,3-bis(4-aminophenyl) propane; 2,2-bis(4-aminophenyl) propane; 4,4′-diamino-diphenyl methane; 1,2-bis(4-aminophenyl) ethane; 1,1-bis(4-aminophenyl) ethane; 2,2′-diamino-diethyl sulfide; bis(4-aminophenyl) sulfide; 2,4′-diamino-diphenyl sulfide; bis(3-aminophenyl) sulfone; bis(4-aminophenyl) sulfone; 4,4′-diamino-dibenzyl sulfoxide; bis(4-aminophenyl) ether; bis(3-aminophenyl) ether; bis(4-aminophenyl)diethyl silane; bis(4-aminophenyl) diphenyl silane; bis(4-aminophenyl) ethyl phosphine oxide; bis(4-aminophenyl) phenyl phosphine oxide; bis(4-aminophenyl)-N-phenyl amine; bis(4-aminophenyl)-N-methylamine; 1,2-diamino-naphthalene; 1,4-diamino-naphthalene; 1,5-diamino-naphthalene; 1,6-diamino-naphthalene; 1,7-diamino-naphthalene; 1,8-diamino-naphthalene; 2,3-diamino-naphthalene; 2,6-diamino-naphthalene; 1,4-diamino-2-methyl-naphthalene; 1,5-diamino-2-methyl-naphthalene; 1,3-diamino-2-phenyl-naphthalene; 4,4′-diamino-biphenyl; 3,3′-diamino-biphenyl; 3,3′-dichloro-4,4′-diamino-biphenyl; 3,3′-dimethyl-4,4′-diamino-biphenyl; 3,4′-dimethyl-4,4′-diamino-biphenyl; 3,3′-dimethoxy-4,4′-diamino-biphenyl; 4,4′-bis(4-aminophenoxy)-biphenyl; 2,4-diamino-toluene; 2,5-diamino-toluene; 2,6-diamino-toluene; 3,5-diamino-toluene; 1,3-diamino-2,5-dichloro-benzene; 1,4-diamino-2,5-dichloro-benzene; 1-methoxy-2,4-diamino-benzene; 1,4-diamino-2-methoxy-5-methyl-benzene; 1,4-diamino-2,3,5,6-tetramethyl-benzene; 1,4-bis(2-methyl-4-amino-pentyl)-benzene; 1,4-bis(1,1-dimethyl-5-amino-pentyl)-benzene; 1,4-bis(4-aminophenoxy)-benzene; o-xylylene diamine; m-xylylene diamine; p-xylylene diamine; 3,3′-diamino-benzophenone; 4,4′-diamino-benzophenone; 2,6-diamino-pyridine; 3,5-diamino-pyridine; 1,3-diamino-adamantane; bis[2-(3-aminophenyl)hexafluoro isopropyl]diphenyl ether; 3,3′-diamino-1,1,1′-diadamantane; N-(3-aminophenyl)-4-aminobenzamide; 4-aminophenyl-3-aminobenzoate; 2,2-bis(4-aminophenyl) hexafluoropropane; 2,2-bis(3-aminophenyl) hexafluoropropane; 2-(3-aminophenyl)-2-(4-aminophenyl)hexafluoropropane; 2,2-bis[4-(4-aminophenoxyl)phenyl]hexafluoropropane; 2,2-bis[4-(2-chloro-4-aminophenoxy)phenyl hexafluoropropane; 1,1-bis(4-aminophenyl)-1-phenyl-2,2,2-trifluoroethane; 1,1-bis[4-(4-aminophenoxyl)phenyl]-1-phenyl-2,2,2-trifluoroethane; 1,4-bis(3-aminophenyl)buta-1-ene-3-in; 1,3-bis(3-aminophenyl) hexafluoropropane; 1,5-bis(3-aminophenyl) decafluoropentane; 4,4′-bis[2-(4-aminophenoxyphenyl) hexafluoro isopropyl]diphenyl ether; diaminocyclohexane; bicyclohexyldiamine; 4,4′-diaminocyclohexylmethane; 2,2′-bis(trifluoromethyl)benzidine (TFDB); diaminofluorene; 1,1-bis(4-aminophenyl)cyclohexane (BACH); 4,4′-(hexafluoro isopropylidene)bis(4-phenoxyaniline) (4,4′-(hexafluoroisopropylidene)bis(4-phenoxyaniline, 6FIDDA); and 9,9-bis(4-aminophenyl)fluorene (BAPF).

The diamine monomer may be used alone or as a mixture of at least two monomers (for example, in order to produce a polyimide copolymer).

However, at least one of the acid dianhydride monomer(s) and the diamine monomer are selected to satisfy the following definition regarding Ar₁ and Ar₂ in Chemical Formula 1: “at least one of Ar₁ and Ar₂ includes an aromatic or aliphatic ring substituted with at least one C1 to C10 fluoroalkyl group; two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group; or a combination thereof.”

Examples of the acid dianhydride monomer for satisfying the aforementioned definition of Chemical Formula 1 may include, but are not limited to, 6FDA; 1,3-bis(3,4-dicarboxy phenyl)hexafluoropropane dianhydride; 1,1-bis(3,4-dicarboxy phenyl)-1-phenyl-2,2,2-trifluoroethane dianhydride; 2,2-bis[4-(3,4-dicarboxyphenoxyl)phenyl]hexafluoropropane dianhydride; 1,1-bis[4-(3,4-dicarboxyphenoxyl)phenyl]-1-phenyl-2,2,2-trifluoroethane dianhydride; 4,4′-bis[2-(3,4-dicarboxy phenyl)hexafluoroisopropyl]diphenyl ether dianhydride; 2,2-bis(3,4-dicarboxy phenyl) propane dianhydride; 2,2-bis[4-(2,3-dicarboxyphenoxyl)phenyl]propane dianhydride; 2,2-bis[4-(3,4-dicarboxyphenoxyl)phenyl]propane dianhydride; 4-(2,3-dicarboxyphenoxy)-4′-(3,4-dicarboxyphenoxyl)diphenyl-2,2-propane dianhydride; and 2,2-bis[4-(3,4-dicarboxyphenoxy-3,5-dimethyl)phenyl]propane dianhydride.

Examples of the diamine monomer for satisfying the aforementioned definition of Chemical Formula 1 may include, but are not limited to, 2,2′-bis(trifluoromethyl)benzidine (TFDB); 2,2-bis(4-aminophenyl) hexafluoropropane; 2,2-bis(3-aminophenyl) hexafluoropropane; 2-(3-aminophenyl)-2-(4-aminophenyl)hexafluoropropane; 2,2-bis[4-(4-aminophenoxyl)phenyl]hexafluoropropane; 2,2-bis[4-(2-chloro-4-aminophenoxy)phenyl hexafluoropropane; 1,1-bis(4-aminophenyl)-1-phenyl-2,2,2-trifluoroethane; 1,1-bis[4-(4-aminophenoxyl)phenyl]-1-phenyl-2,2,2-trifluoroethane; 1,3-bis(3-aminophenyl) hexafluoropropane; 1,5-bis(3-aminophenyl) decafluoropentane; 4,4′-bis[2-(4-aminophenoxyphenyl)hexafluoroisopropyl]diphenyl ether; diaminocyclohexane; bicyclohexyldiamine; 4,4′-diaminocyclohexyl methane; diaminofluorene; 1,1-bis(4-aminophenyl)cyclohexane (BACH); 4,4′-(hexafluoroisopropylidene)bis(4-phenoxyaniline) (4,4′-(hexafluoroisopropylidene)bis(4-phenoxyaniline, 6FIDDA); and 9,9-bis(4-aminophenyl)fluorene (BAPF).

The mole ratio of the acid dianhydride monomer to the diamine (acid dianhydride/diamine) may range from about 0.95 to about 1.1, for example, from about 0.99 to about 1.05.

The condensation polymerization is carried out by stirring a composition including the foregoing monomers at a predetermined temperature (e.g., at a temperature of about 50° C. or lower) in air or under an inert gas atmosphere. The specific conditions and a general mechanism of the condensation polymerization are known in the literature and are available to one of ordinary skill in the art. The polymerization manners are not particularly limited and may be selected appropriately.

For example, the polycondensation may be carried out in a solution optionally including a polycondensation catalyst. In case of the solution polymerization, any solvent available for the preparation of the polyamic acid may be used as a solvent for the polymerization. Examples of the solvent may include, but are not limited to, γ-butyrolactone, monochlorobenzene, and a dipolar aprotic solvent such as N-methylpyrrolidone, dimethylacetamide, dimethyl formamide, and dimethyl sulfoxide. Examples of the catalyst for the condensation polymerization may include, but are not limited to, p-toluene sulfonic acid. When the given acid dianhydride monomer is added to the given diamine monomer, optionally in the presence of the catalyst, at a predetermined temperature, the amino group may undergo a nucleophilic attack on the carbon atom of the carbonyl group to trigger a condensation reaction. The duration and the temperature of the polymerization may be appropriately selected in light of the types of the monomer. For example, the polymerization is carried out at a temperature of less than or equal to about 50° C., for example, about −20° C. to about 30° C., for 30 minutes or longer, for example, for one hour or longer. The concentration of the monomers may be appropriately selected and is not particularly limited. As mentioned above, the acid dianhydride monomer and the diamine monomer may be commercially available or may be readily synthesized via any known method.

The polyamic acid thus prepared is subjected to imidization to obtain a partially imidized polyimide. Prior to or after the imidization, a drying may be carried out at a temperature of less than or equal to about 500° C., for example, less than or equal to about 450° C., less than or equal to about 400° C., less than or equal to about 350° C., less than or equal to about 300° C., less than or equal to about 250° C., less than or equal to about 200° C., less than or equal to about 100° C., or less than or equal to about 50° C. to remove the solvent. In an embodiment, the imidization is carried out by chemical imidization. Specific conditions for the chemical imidization are known in the literature and are available to one of ordinary skill in the art. For example, the chemical imidization may be conducted by treating the polyamic acid (co)polymer with a reagent such as aliphatic carboxylic acid diacid anhydride and a tertiary amine for example at an ambient temperature. Examples of the reagent being widely used may include acetic acid anhydride, pyridine, and triethylamine. In this case, the degree of the imidization may vary depending on the solubility of the polyimide in the imidization product. The product of the chemical imidization may be prepared as a film. Alternatively, the product of the chemical imidization may be recovered first, redissolved in an appropriate solvent (e.g., N-methylpyrrolidone, dimethylacetamide, γ-butyrolactone, monochlorobenzene, or the like), and then prepared as a film.

The partially imidized polyimide may have a degree of imidization of less than 100%, for example, less than or equal to about 99%, less than or equal to about 98%, less than or equal to about 97%, less than or equal to about 96%, less than or equal to about 95%, less than or equal to about 94%, less than or equal to about 93%, less than or equal to about 92%, less than or equal to about 91%, less than or equal to about 90%, less than or equal to about 89%, less than or equal to about 88%, less than or equal to about 87%, less than or equal to about 86%, or less than or equal to about 85%. The degree of the imidization of the partially imidized polyimide may be determined by FT-IR spectroscopy. The calculation of the degree of the imidization may be made by comparing the peak size of the vC-N absorption band at 1,380 cm⁻¹ (i.e., the characteristic band for the imide group) and the relative peak size of the aromatic C═C stretching band at 1,500 cm⁻¹.

After the partially imidized polyimide is prepared as a film, a dynamic mechanical analysis of the prepared film is conducted to determine its sub-Tg temperature. For example, the partially imidized polyimide is dissolved in an appropriate solvent (e.g., N-methylpyrrolidone, dimethylacetamide) and applied to any suitable substrate to form a film. The polyimide film of the partially imidized polyimide includes a residual solvent in an amount of at least about 10% by weight. The polyimide film of the partially imidized polyimide includes a residual solvent in an amount of less than or equal to about 40% by weight.

The sub-Tg temperature may be determined at a temperature of the first tan δ peak in a temperature sweep from a dynamic mechanical analysis of the film at a predetermined frequency. The frequency may be selected appropriately and is not particularly limited. The height of the first peak may be greater than or equal to about 0.1. The sub-Tg temperature of the partially imidized polyimide may be within a range of about 100° C. to about 250° C. Specific conditions for the dynamic mechanical analysis are known in the art. The dynamic mechanical analysis may be made by using any suitable known or commercially available equipment.

Then, the partially imidized polyimide is heat-treated in at least two steps (e.g., in a two-step, three-step, or four-step process) and the step-transition temperature range (i.e., a region where the temperature sharply (or rapidly) rises) includes a temperature within the sub-Tg temperature±30° C. The term “the step-transition temperature range including a temperature of the sub-Tg temperature±30° C.” refers to the case where the step-transition temperature range covers the entire range of the sub-Tg temperature±30° C. or the case where the step-transition temperature range partially overlaps the range defined by the sub-Tg temperature±30° C. As used herein, the term “step-transition temperature range” refers to a range defined by the final temperature (T1_{final}) of a step (e.g., a first step) and the initial temperature (T2ᵢₙᵢₜᵢₐₗ) of a directly subsequent step (e.g. a second step). The final temperature (T1_{final}) of a step refers to a predetermined temperature or the highest temperature of the given step. In each step, the temperature, the heating rate, and the duration of the heat-treating may be independently determined provided that the step-transition temperature range includes a temperature of the sub-Tg temperature±30° C.

In an embodiment, the method may include a first heat-treating step having the final temperature (T1_{final}) of less than the sub-Tg temperature+30° C., for example, within the range defined by the sub-Tg temperature±30° C. or less than the sub-Tg temperature−30° C.; and a second heat-treating step having the initial temperature (T2ᵢₙᵢₜᵢₐₗ) of greater than the sub-Tg temperature−30° C., for example, within the range defined by the sub-Tg temperature±30° C. or greater than the sub-Tg temperature−30° C., wherein the second heat-treating step is conducted directly after the first heat-treating step, and the initial temperature of the second heat-treating step (T2ᵢₙᵢₜᵢₐᵢ) is greater than the final temperature of the first heat-treating step (T1_{final}).

In the first heat-treating step, the final temperature of the first heat-treating step (T1_{final}) may be the highest temperature or a predetermined temperature. As used herein, the term “the first heat-treating step” does not necessarily mean a heat-treating step being conducted first. In other words, prior to the first heat-treating step, it is possible to conduct a heat-treating step having the highest and final temperature of less than the sub-Tg temperature+30° C. In an embodiment, the first heat treating step may be carried out at a constant temperature (T1_{final}) for a predetermined time (e.g., at least 0.5 minutes). In other embodiments, the first heat-treating step may be carried out by heating a film at a predetermined heating rate (e.g., about 10° C./min or lower, or about 4° C./min) up to the final temperature (T1_{final}).

The second heat-treating step is conducted directly after the first heat-treating step. In the second heat-treating step, the film is heated at the initial temperature (T2ᵢₙᵢₜᵢₐₗ) of greater than the sub-Tg temperature−30° C., for example, at a temperature of greater than the sub-Tg temperature−30° C. and less than the sub-Tg temperature+30° C., or greater than the sub-Tg temperature+30° C., provided that the initial temperature (T2ᵢₙᵢₜᵢₐₗ) is higher than the final temperature of the first heat-treating step (T1_{final}) In an embodiment, the initial temperature of the second heat-treating step (T2ᵢₙᵢₜᵢₐₗ) may be greater than or equal to about the sub-Tg temperature+30° C., for example greater than or equal to about the sub-Tg temperature+40° C., or greater than or equal to about the sub-Tg temperature+50° C. In an embodiment, the second heat treating step may be carried out at a temperature increasing at a predetermined rate. The duration for the second heat-treating step may be selected as needed to remove a remaining solvent and a residual stress.

The polyimide film prepared in accordance with the aforementioned embodiments may exhibit excellent transparency and greatly reduced out-of-plane retardation (Rₜₕ) while maintaining high thermal stability. The out-of-plane retardation (Rₜₕ) is a type of phase retardance, which occurs due to the velocity difference between the light component vibrating in the direction of the thickness and the light component vibrating in the direction of the plane. The out-of-plane retardation (Rₜₕ) may be defined by the following equation.

Rₜₕ=Δn×d

Herein,

d is thickness,

Δn (birefringence)=[(nₓ+n_{y})/2−n_{z})], and

nₓ, n_{y}, and n_{z} are defined as above.

The thickness of the film is not particularly limited, and is selected appropriately. For example, the thickness of the film may be less than or equal to about 200 micrometers (μm), for example, from about 5 μm to about 100 μm.

In the displays such as an LCD, an increased out-of-plane retardation may cause light leakage, a smaller viewing angle, and a reduced contrast ratio. Therefore, in order for a high-definition display to be realized, the out-of-plane retardation is required to be small. Using an optical film having a low value of the out-of-plane retardation enables a wider viewing angle. In addition, for the optical film having high retardation, a compensation film is also used to lower the influence thereof. However, the retardation that may be controlled (i.e., lowered) by the use of the compensation film may be about 150 nm to about 300 nm.

Meanwhile, materials for the flexible substrate may be required to have high thermal stability, and to this end, a polyimide film has been proposed to have an increased aromatic amount by using a rigid monomer, aromatic acid dianhydrides and aromatic diamines. In order to increase transparency of the polyimide, the proposed polyimide film uses a monomer containing fluorine such as 6FDA, TFDB, or 6FIDDA. However, such a conventional polyimide film has greatly increased (for example, 1,000 nm or higher) retardation. In order to address such a high retardation, an attempt has been made to use a monomer including an alicyclic ring such as 1,1-bis(4-aminophenyl)cyclohexane (BACH) or 9,9-bis(4-aminophenyl)fluorine. Using such an alicyclic monomer may decrease the phase retardation, but at the same time may cause deterioration of thermal stability and may also have an adverse effect on the transparency of the resulting film. Therefore, according to the conventional technologies, it has been practically impossible to prepare a polyimide transparent film having high thermal stability and transparency together with low phase retardation.

Surprisingly, the production method of the aforementioned embodiments may address the problems of the conventional technologies. In other words, the polyimide film prepared by the aforementioned method may exhibit a greatly reduced value of the phase retardation and, at the same time, may maintain a high level of thermal stability and transparency. In an embodiment, wherein a thickness of the polyimide film is about 40 μm, the polyimide film prepared by the aforementioned method may have the out-of-plane retardation (Rth) of less than or equal to about 300 nm, for example, less than or equal to about 290 nm, less than or equal to about 250 nm, less than or equal to about 200 nm, less than or equal to about 190 nm, less than or equal to about 180 nm, less than or equal to about 120 nm, or even less than or equal to about 100 nm. In an embodiment, the polyimide film has a birefringence of less than or equal to about 0.025, for example, less than or equal to about 0.01, less than or equal to about 0.009, less than or equal to about 0.008, less than or equal to about 0.007, less than or equal to about 0.006, or less than or equal to about 0.005. While it has such a low level of the out-of-plane retardation or the birefringence, the polyimide film may show high thermal stability. By way of an example, in a thermogravimetric analysis, the polyimide film may have a 0.5% weight loss temperature of greater than or equal to about 460° C., for example, greater than or equal to about 470° C. In addition, with respect to light having a wavelength of 430 nm, the polyimide film may show transmittance of greater than or equal to about 75%, for example, greater than or equal to about 76%, greater than or equal to about 77%, greater than or equal to about 78%, greater than or equal to about 79%, or greater than or equal to about 80%. In addition, with respect to the entire range light having a wavelength from about 380 nm to 800 nm, the polyimide film may show transmittance of greater than or equal to about 85%.

In other embodiment, a polyimide film including a polyimide having a repeating unit represented by Chemical Formula 2, has birefringence (Δn) of less than or equal to about 0.025, and has a decomposition temperature of 0.5% weight loss that is greater than or equal to about 460° C.

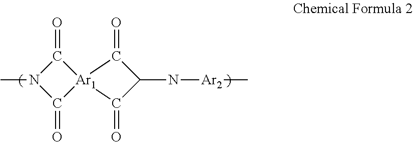

Herein, Ar₁ is a moiety selected from a substituted or unsubstituted tetravalent C5 to C24 aliphatic cyclic group, a substituted or unsubstituted tetravalent C6 to C24 aromatic cyclic group, and a substituted or unsubstituted tetravalent C6 to C24 heteroaromatic cyclic group, wherein the aliphatic or (hetero) aromatic cyclic group is present alone, at least two groups selected from the aliphatic cyclic group and the heteroaromatic cyclic group are fused to form a polycyclic aromatic ring, or at least two groups selected from the aliphatic cyclic group and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof;

Ar₂ is a moiety selected from a substituted or unsubstituted divalent C5 to C24 aliphatic cyclic group, a substituted or unsubstituted divalent C6 to C24 aromatic cyclic group, and a substituted or unsubstituted divalent C4 to C24 heteroaromatic cyclic group, and -L-SiR₂—O—SiR₂-L- (wherein L is a single bond or a C1 to C10 alkylene group), wherein the aliphatic cyclic group or the heteroaromatic cyclic group is present alone, at least two groups selected from the aliphatic cyclic group and the heteroaromatic cyclic group are fused to form a polycyclic aromatic ring, or at least two groups selected from the aliphatic cyclic group and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 divalent alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof; and

wherein at least one of Ar₁ and Ar₂ includes an aromatic or aliphatic ring substituted with at least one C1 to C10 fluoroalkyl group, two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group, or a combination thereof.

Definitions of the Ar₁ and Ar₂ are the same as set forth above.

The polyamide may be a polyimide copolymer including at least two different repeating units that are represented by Chemical Formula 2 that differ in Ar₁, Ar₂, or both.

In other embodiments, an electronic device may include the foregoing polyimide film.

The electronic device may be a flat or curved panel display, a touch screen panel, a photovoltaic cell, an e-window, a heat mirror, a transparent transistor, a flexible display, a complementary metal-oxide semiconductor, or light emitting diode lighting.

Hereinafter, the technology of this disclosure is described in detail with reference to examples. The following examples and comparative examples are not restrictive but are illustrative.

### EXAMPLES

### Reference Example 1

### Preparation of a Partially Imidized Polyimide (CLPI) Film and Determination of its Sub-Tg Temperature

62,000 g of dimethylacetamide (DMAc) and 6,500 g of 2,2′-bis(trifluoromethyl)benzidine (TFDB) are placed into a reactor and stirred for one hour to prepare a diamine solution. 4,479 g of biphenyl dianhydride (BPDA) is added to the diamine solution and the resulting mixture is stirred for 18 hours. 2,209 g of 4,4′-(hexafluoroisopropylidene)diphthalic anhydride (6FDA) is quickly introduced thereto. The final mixture is stirred at room temperature for 18 hours to obtain a solution of a polyamic acid as a product of a condensation polymerization.

2480 g of acetic anhydride is added to the solution of the polyamic acid and stirred for 30 minutes. Then, 640 g of pyridine is added in three portions with a time interval of 30 minutes between added portions. The resulting mixture is stirred for about 18 hours to obtain a composition including partially imidized polyimide.

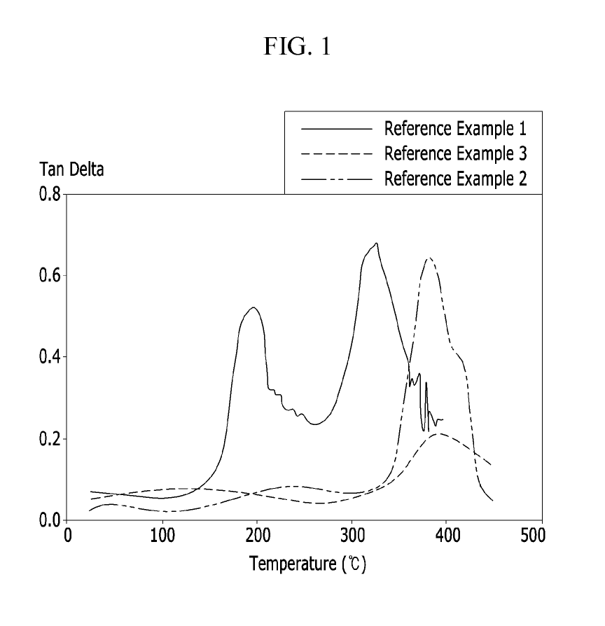

The composition of the partially imidized polyimide is casted onto a glass substrate and dried at 120° C. to 140° C. to obtain a film, which is then peeled off from the glass substrate. The obtained film is subjected to dynamic mechanical analysis using DMA (TA Q800) manufactured by TA instrument Inc., in a temperature sweep mode under the following conditions: Frequency 0.3 Hz, Oscillation Strain 0.0750%, and Static Force 0.005 N. The results are shown in FIG. 1. From the results of FIG. 1, the sub-Tg temperature of the prepared polyimide is 191° C.

### Reference Example 2

### Preparation of a Partially Imidized Polyamide-Imide Film and a DMA Analysis Thereof

(1) Preparation of the Polyamic Acid Solution

5,808 g (23.4 mol) of 4,4-diamino diphenyl sulfone and 14,108 g of dimethylacetamide are placed into a 50 L double-jacketed reactor at a temperature of 20° C. and under a nitrogen atmosphere and stirred to prepare a solution. 6,930.1 g (15.6 mol) of 6-FDA is added to the solution. The monomer remaining on the inner wall of the reactor may be removed therefrom by using dimethylacetamide. The final mixture is stirred at 20° C. for 20 hours to obtain a 40 wt % polyamic acid composition.

(2) Preparation of the Polyamide Prepolymer

1,143 g (4.068 mol) of 4,4-diaminodiphenylsulfone, 1,475 g (4.068 mol) of TFDB, and 20,000 g of dimethylacetamide are placed in a 100 L reactor at a temperature of 20° C. under a N₂ atmosphere. The monomer remaining on the inner wall of the reactor may be removed therefrom by using dimethylacetamide. The mixture is stirred until the introduced monomers are completely dissolved and the resulting solution is cooled to about 5° C. 1,286 g (4.068 mol) of diphenyl diacid chloride are gradually added thereto and the resulting mixture is stirred to carry out polymerization at 10° C. for one hour to obtain a polyamide prepolymer solution.

(3) Formation of the Block Copolymer

The temperature of the reactor containing the polyamide prepolymer solution is lowered to 5° C. 3,135 g of the polyamic acid composition and 32,140 g of dimethylacetamide are added to the reactor. Then, 1,091 g (5.376 mol) of terephthalic acid chloride is slowly added thereto and the reaction mixture is stirred at 10° C. for one hour to obtain a poly(amic acid-amide) block copolymer.

(4) Chemical Imidization

The reactor containing the poly(amic acid-amide) block copolymer is warmed to about 20° C. 627 g (6.144 mol) of acetic anhydride is added to the reactor and the reaction mixture is stirred for 30 minutes. 2065 g (26.112 mol) of pyridine is added thereto and the reaction mixture is stirred for 15 to 18 hours to conduct imidization to obtain a composition including poly(imide-amide). FT-IR spectroscopy confirms that the degree of the imidization of the poly(imide-amide) is 100%.

The degree of the imidization is confirmed by the FT-IR spectroscopy. The calculation of the degree of imidization may be made by comparing the size of the peak of the vC-N absorption band (i.e., the imide band) at 1,380 cm⁻¹ with the size of the peak of the aromatic C═C stretching band at 1,500 cm⁻¹.

The composition of the poly(imide-amide) is casted onto a glass substrate and dried at 120° C. to 140° C. to obtain a film, which is then peeled off from the glass substrate. The obtained film having a thickness of about 50 micrometers (um) is subjected to a dynamic mechanical analysis in the same manner as set forth in Reference Example 1. The results are shown in FIG. 1. From the results of FIG. 1, the sub-Tg temperature of the prepared polyimide is 230° C. The temperature of the first gentle peak at 230° C. in FIG. 1 is determined as the sub-Tg temperature.

### Reference Example 3

### Preparation of PMDA-ODA Polyimide and a DMA Analysis Thereof

79.5 kg of dimethylacetamide is placed in a 100 L reactor and heated to 40° C. while stirring. 9,572 g of 4,4-oxydiphenylamine (ODA) is placed into the reactor and completely dissolved by stirring the same at 40° C. for 1.5 hours to obtain a solution. 10,375 g of pyromellitic anhydride is added to the solution and thereby the temperature of the reaction mixture increases up to a temperature between 55° C. and 60° C. (the mole ratio between PMDA:ODA=1:0.995). The reaction mixture is stirred at 45° C. for 17 hours to obtain a solution containing polyamic acid. The viscosity of the obtained solution is between about 10,000 centipoises (cps) and about 300,000 cps.

The solution of the polyamic acid is casted onto a glass substrate and dried at 120° C. to 140° C. to obtain a film, which is then peeled off from the glass substrate. The obtained film is subjected to a dynamic mechanical analysis in the same manner as set forth in Reference Example 1. The results are shown in FIG. 1. From the results of FIG. 1, the sub-Tg temperature of the prepared polyimide is 130° C.

### Example 1

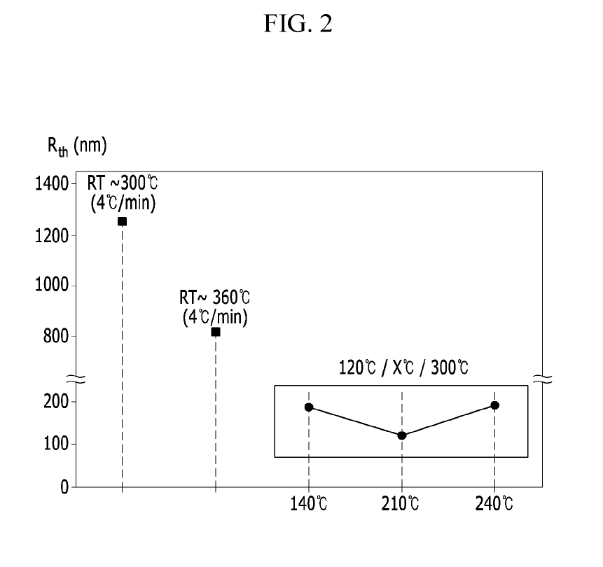

The film prepared in Reference Example 1 is stretched and fixed onto a tenter frame having a size of 10 cm×10 cm, and is subsequently heat-treated at a temperature of 120° C. for 5 minutes and at a temperature of 140° C. for 5 minutes. Then, the film is heat-treated again at a temperature of 300° C. for 5 minutes. For the heat-treated polyimide film, the out-of-plane retardation and the birefringence are measured as described below, and the results are compiled in Table 1 and FIG. 2.

Using Axoscan of Axomatrix Inc., the out-of-plane retardation and the birefringence are measured according to the manufacturer's manual with respect to light having a wavelength of 550 nm or 589 nm.

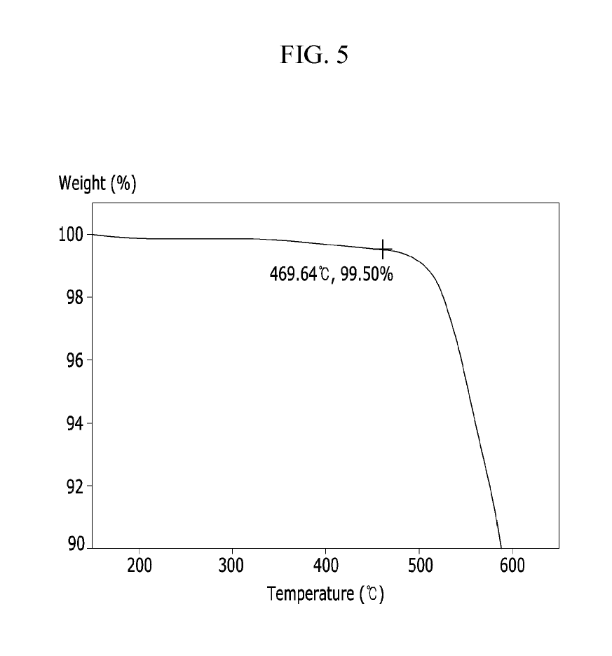

For the heat-treated polyimide film, the decomposition temperature of 0.5% weight loss is measured using a thermogravimetric analyzer (TA TGA Q500) at a heating rate of 10-30° C./min under a N₂ purge, and the results are shown in FIG. 5. The results of FIG. 5 confirm that the temperature of 0.5% weight loss is 469.64° C.

For the prepared polymer film, the light transmittance is measured as follows.

A sample of 300 mm×300 mm is prepared and the transmittance is measured using a spectrophotometer (manufactured by Minolta Co., Ltd., model name: CM-3600d).

The results confirm that the polymer film has a high level of whole light transmittance and the transmittance with respect to light having a wavelength of 430 nm, which is 88.68% and 84.35%, respectively.

### Example 2

A heat-treated polyimide film is obtained in the same manner as set forth in Example 1, except that the film prepared in Reference Example 1 is heat-treated at a temperature of 120° C. for 5 minutes, at a temperature of 180° C. for 5 minutes, and is subsequently heat-treated at a temperature of 300° C. for 5 minutes.

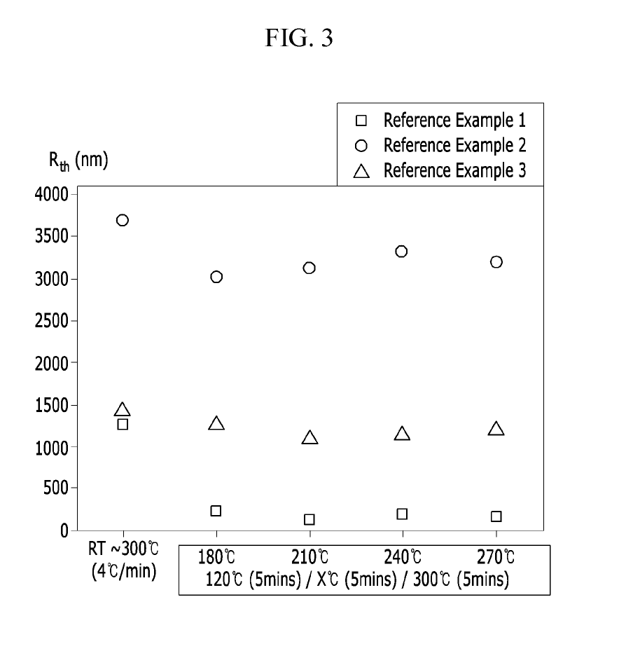

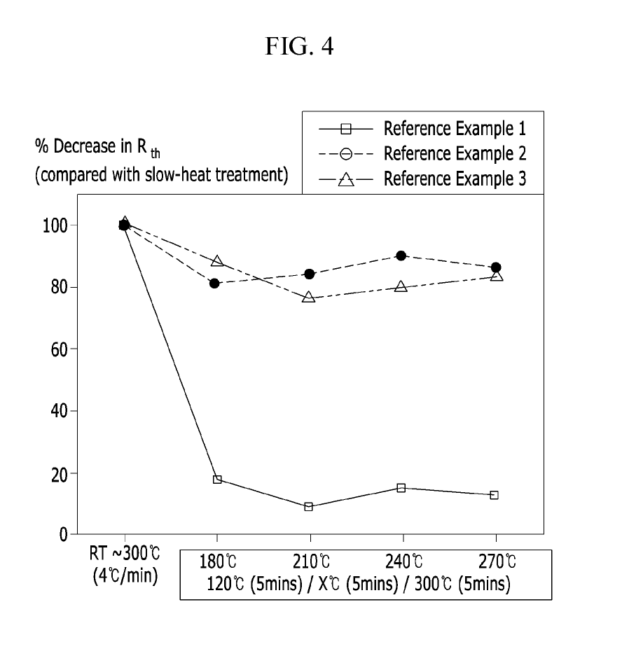

For the heat treated polyimide film, the out-of-plane retardation and the birefringence are measured in the same manner as in Example 1, and the results are compiled in Table 1, FIG. 3, and FIG. 4.

### Example 3

A heat-treated polyimide film is obtained in the same manner as set forth in Example 1, except that the film prepared in Reference Example 1 is heat-treated at a temperature of 120° C. for 5 minutes, at a temperature of 210° C. for 5 minutes, and is subsequently heat-treated at a temperature of 300° C. for 5 minutes.

For the heat treated polyimide film, the out-of-plane retardation and the birefringence are measured in the same manner as in Example 1, and the results are compiled in Table 1, FIG. 1, FIG. 2, and FIG. 3.

### Example 4

A heat-treated polyimide film is obtained in the same manner as set forth in Example 1, except that the film prepared in Reference Example 1 is heat-treated at a temperature of 120° C. for 5 minutes, at a temperature of 240° C. for 5 minutes, and is subsequently heat-treated at a temperature of 300° C. for 5 minutes.

For the heat treated polyimide film, the out-of-plane retardation and the birefringence are measured in the same manner as in Example 1, and the results are compiled in Table 1, FIG. 1, FIG. 2, and FIG. 3.

### Example 5

A heat-treated polyimide film is obtained in the same manner as set forth in Example 1, except that the film prepared in Reference Example 1 is heat-treated at a temperature of 120° C. for 5 minutes, at a temperature of 270° C. for 5 minutes, and is subsequently heat-treated at a temperature of 300° C. for 5 minutes.

For the heat treated polyimide film, the out-of-plane retardation and the birefringence are measured in the same manner as in Example 1, and the results are compiled in Table 1, FIG. 3, and FIG. 4.

### Example 6

A heat-treated polyimide film is obtained in the same manner as set forth in Example 1, except that the film prepared in Reference Example 1 is heated from room temperature to 210° C. at a heating rate of 4° C./min, and then is heat-treated at a temperature of 300° C. for 5 minutes.

For the heat treated polyimide film, the out-of-plane retardation and the birefringence are measured in the same manner as in Example 1, and the results are compiled in Table 1.

### Comparative Example 1

A heat-treated polyimide film is obtained in the same manner as set forth in Example 1, except that the film prepared in Reference Example 1 is heated from room temperature to 300° C. at a heating rate of 4° C./min.

For the heat treated polyimide film, the out-of-plane retardation and the birefringence are measured in the same manner as in Example 1, and the results are compiled in Table 1, FIG. 3, and FIG. 4.

### Comparative Example 2

A heat-treated polyimide film is obtained in the same manner as set forth in Example 1, except that the film prepared in Reference Example 1 is heated from room temperature to 360° C. at a heating rate of 4° C./min.

For the heat treated polyimide film, the out-of-plane retardation and the birefringence are measured in the same manner as in Example 1, and the results are compiled in Table 1.

### Comparative Example 3

A heat-treated polyimide film is obtained in the same manner as set forth in Example 1, except that the film prepared in Reference Example 1 is heated from room temperature to 230° C. at a heating rate of 4° C./min, and then is heat-treated at a temperature of 300° C. for 5 minutes.

For the heat treated polyimide film, the out-of-plane retardation and the birefringence are measured in the same manner as in Example 1, and the results are compiled in Table 1.

### Comparative Example 4

A heat-treated polyimide film is obtained in the same manner as set forth in Example 1, except that the film prepared in Reference Example 1 is heated from room temperature to 250° C. at a heating rate of 4° C./min, and then is heat-treated at a temperature of 300° C. for 5 minutes.

For the heat treated polyimide film, the out-of-plane retardation and the birefringence are measured in the same manner as in Example 1, and the results are compiled in Table 1.

### Comparative Example 5

A heat-treated polyimide film is obtained in the same manner as set forth in Example 1, except that the film prepared in Reference Example 1 is heat-treated at a temperature of 120° C. for 5 minutes and then is heated from 120° C. to 300° C. at a heating rate of 4° C./min.

For the heat treated polyimide film, the out-of-plane retardation and the birefringence are measured in the same manner as in Example 1, and the results are compiled in Table 1.

### Comparative Example 6

A heat-treated polyimide film is obtained in the same manner as set forth in Example 1, except that the film prepared in Reference Example 1 is heat-treated at a temperature of 150° C. for 5 minutes and then is heated from 150° C. to 300° C. at a heating rate of 4° C./min.

For the heat treated polyimide film, the out-of-plane retardation and the birefringence are measured in the same manner as in Example 1, and the results are compiled in Table 1.

### Comparative Example 7

A heat-treated polyimide film is obtained in the same manner as set forth in Example 1, except that the poly(amide-imide) film prepared in Reference Example 2 is heated from room temperature to 360° C. at a heating rate of 4° C./min.

For the heat treated polyimide film, the out-of-plane retardation and the birefringence are measured in the same manner as in Example 1, and the results are compiled in Table 1.

### Comparative Example 8

A heat-treated polyimide film is obtained in the same manner as set forth in Example 1, except that the poly(amide-imide) film prepared in Reference Example 2 is heat-treated at a temperature of 120° C. for 5 minutes and at a temperature of 180° C. for 5 minutes, and then is heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 9

A heat-treated polyimide film is obtained in the same manner as set forth in Example 1, except that the poly(amide-imide) film prepared in Reference Example 2 is heat-treated at a temperature of 120° C. for 5 minutes, at a temperature of 210° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 10

A heat-treated polyimide film is obtained in the same manner as set forth in Example 1, except that the poly(amide-imide) film prepared in Reference Example 2 is heat-treated at a temperature of 120° C. for 5 minutes, at a temperature of 240° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 11

A heat-treated polyimide film is obtained in the same manner as set forth in Example 1, except that the poly(amide-imide) film prepared in Reference Example 2 is heat-treated at a temperature of 120° C. for 5 minutes, at a temperature of 270° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 12

A heat-treated polyimide film is obtained in the same manner as set forth in Example 1, except that the Kapton film prepared in Reference Example 3 is heated from room temperature to 360° C. at a heating rate of 4° C./min.

For the heat treated polyimide film, the out-of-plane retardation and the birefringence are measured in the same manner as in Example 1, and the results are compiled in Table 1.

### Comparative Example 13

A heat-treated polyimide film is obtained in the same manner as set forth in Example 1, except that the Kapton film prepared in Reference Example 3 is heat-treated at a temperature of 120° C. for 5 minutes, at a temperature of 180° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 14

A heat-treated polyimide film is obtained in the same manner as set forth in Example 1, except that the Kapton film prepared in Reference Example 3 is heat-treated at a temperature of 120° C. for 5 minutes, at a temperature of 210° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 15

A heat-treated polyimide film is obtained in the same manner as set forth in Example 1, except that the Kapton film prepared in Reference Example 3 is heat-treated at a temperature of 120° C. for 5 minutes, at a temperature of 240° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

### Comparative Example 16

A heat-treated polyimide film is obtained in the same manner as set forth in Example 1, except that the Kapton film prepared in Reference Example 3 is heat-treated at a temperature of 120° C. for 5 minutes, at a temperature of 270° C. for 5 minutes, and is subsequently heat-treated at a temperature of 300° C. for 5 minutes.

For the heat treated polyimide film, the out-of-plane retardation and the birefringence are measured in the same manner as in Example 1, and the results are summarized in FIG. 3 and FIG. 4.

TABLE 1

| | | Step transition | Rₜₕ | Thickness | |
|---|---|---|---|---|---|
| | Heat-treating conditions | temp. range | (nm) | (μm) | Birefringence |
| Example 1 | 120° C. + 5 min + 140° C. + 5 min + | Includes at | 185 | 40 | 0.0046 |
| | 300° C. + 5 min | least one | | | |
| Example 2 | 120° C. + 5 min. + 180° C. + 5 min. + | temperature | | | |
| | 300° C. + 5 min. | of the sub-Tg | | | |
| Example 3 | 120° C. + 5 min + 210° C. + 5 min + | range | 120 | 40 | 0.0030 |
| | 300° C. + 5 min | (191° C.) ± | | | |
| Example 4 | 120° C. + 5 min + 240° C. + 5 min + | 30° C. | 191 | 41 | 0.0047 |
| | 300° C. + 5 min | | | | |
| Example 5 | 120° C. + 5 min + 270° C. + 5 min + | | | | |
| | 300° C. + 5 min | | | | |
| Example 6 | RT to 210° C. at 4° C./min + | | 85 | 39 | 0.0022 |
| | 300° C. + 5 min | | | | |
| Comp. | RT to 300° C. at 4° C./min | Does not | 1811 | 38 | 0.0477 |
| Example 1 | | include at | | | |
| Comp. | RT to 360° C. at 4° C./min | least one | 1019 | 38 | 0.0268 |
| Example 2 | | temperature | | | |
| Comp. | RT to 230° C. at 4° C./min + | of the sub-Tg | 1162 | 40 | 0.0291 |
| Example 3 | 300° + 5 min | range | | | |
| Comp. | RT to 250° C. at 4° C./min + | (191° C.) ± | 1556 | 40 | 0.0389 |
| Example 4 | 300° C. + 5 min | 30° C. | | | |
| Comp. | 120° C. + 5 min + 120 to 300° C. at | | 1648 | 41 | 0.0402 |
| Example 5 | 4° C./min | | | | |
| Comp. | 150° C. + 5 min + 150 to 300° C. at | | 1593 | 42 | 0.0379 |
| Example 6 | 4° C./min | | | | |

RT: room temperature

The results of Table 1 confirm that when the step transition temperature range includes the sub-Tg temperature (191° C.)±30° C., the heat-treated polyimide film may show greatly reduced Rₜₕ. For example, in the heat-treating of Example 1, the step transition temperature from 140° C. to 300° C. includes the sub-Tg temperature (191° C.)±30° C. In the heat-treating of Examples 2 to 5, the step transition temperatures, which are from 120° C. to 180° C., from 120° C. to 210° C., from 120° C. to 240° C., and from 120° C. to 270° C., respectively, include at least one temperature of the sub-Tg temperature (191° C.)±30° C. In Example 6, the range defined by the final temperature of the first heat-treating (i.e., 210° C.) and the initial temperature of the second heat-treating (i.e., 300° C.) includes at least one temperature of the sub-Tg temperature (191° C.)±30° C. The heat-treated polyimide films of Examples 1 to 6 have out-of-plane retardation (Rth) and birefringence that are significantly lower than the films of the comparative examples as described below.

In contrast, as illustrated by Comparative Examples 1 to 6, the step transition temperature range does not include a temperature within the sub-Tg temperature (191° C.)±30° C. and the films thus prepared have a very high value of the out-of-plane retardation, even though they have the same composition as of the films prepared according to Examples 1 to 6.

The results of FIG. 2 confirm that the out-of-plane retardation of the films of Examples 1, 3, and 4 is significantly lower than the film prepared by a gradual heating up to 300° C.

The results of FIG. 3 and FIG. 4 confirm that the out-of-plane retardation of the films of Examples 1, 3, 4, and 5 is significantly lower than the film of Comparative Example 1 having the identical chemical composition. The films of Examples 1, 3, 4, and 5 are prepared by stepwise heat-treating of the polyamic acid of Chemical Formula 1, wherein the step transition temperature range includes a temperature of the sub-Tg temperature (191° C.)±30° C.

In contrast, the films prepared in Comparative Examples 8 to 11 have a high level of out-of-plane retardation. In Comparative Examples 8 to 11, the poly(amide-imide) having a 100% imidization degree (not the partially imidized polyimide) is subjected to heat-treating under the same conditions as Examples 1, 3, 4, and 5, respectively.

Like the film of Comparative Example 12, the films of Comparative Examples 13 to 16 have a high level of out-of-plane retardation. In Comparative Examples 13 to 16, the polyimide (Kapton) that fails to satisfy the conditions of Chemical Formula 1 is subjected to stepwise heat-treating under the same conditions as in Examples 1, 3, 4, and 5, respectively. The films of Comparative Examples 8 to 11 and the films of Comparative Examples 13 to 16 have a high level of out-of-plane retardation such as 1,000 nm or higher (as high as about 3,000 nm).

The results of FIG. 5 confirm that the polyimide film of Example 1 has a low level of Rth and birefringence together with excellent thermal stability. It may be understood that the films of Examples 2 to 6 may have substantially the same or similar level of thermal stability as the polyimide film of Example 1.

### Example 17

159.53 mL of N-methylpyrrolidone is added to a 250 mL reactor. 19.24 g (0.601 mol) of 2,2′-bis(trifluoromethyl)benzidine (TFDB) and an amount set forth in Table 1 of 1,1-bis(4-aminophenyl)cyclohexane (BACH) are placed in the reactor and completely dissolved therein to prepare a diamine solution. 14.14 g (0.481 mol) of 3,3′,4,4′-biphenyltetracarboxylic acid dianhydride (BPDA) and 2.62 g (0.120 mol) of pyromellitic dianhydride (PMDA) are quickly added to the diamine solution and stirred at room temperature for 48 hours to obtain a solution of the polyamic acid copolymer as a product of condensation polymerization.

The obtained solution is spin-coated to form a film, which is then first-dried on a hot plate at 80° C. for 30 minutes. Then, the dried film is placed in a furnace and is heated from room temperature to about 300° C. at a heating rate of 10° C./min to obtain a polyimide film.

For the polyimide film, the out-of-plane retardation and the birefringence are measured in the same manner as Example 1, and the results are compiled in Table 2.

For the polyimide film, the light transmittance is measured using a spectroscopic colorimeter (CM-3600D), and the results are compiled in Table 2.

For the heat-treated polyimide film, a thermogravimetric analysis is conducted using a thermogravimetric analyzer (TA TGA Q500) at a heating rate of 10-30° C./min under a nitrogen purge to measure the decomposition temperature of 0.5% weight loss. The results are compiled in Table 2.

TABLE 2

| | | | | | | Td @ |
|---|---|---|---|---|---|---|
| | | | | Rth @ | | 0.5 wt % |
| BACH | TFDB | Transmittance(%) | | 10 μm | Birefrin- | weight |
| (mol %) | (mol %) | Total | 430 nm | (nm) | gence | loss (he |
| 0 | 100 | 87.56 | 81.62 | 1200 | 0.12 | 485.8 |
| 0.5 | 95.5 | 87.42 | 81.41 | 758 | 0.0758 | 467.2 |
| 1 | 99 | 87.57 | 83.95 | 860 | 0.0860 | 468.8 |
| 5 | 95 | 87.58 | 82.27 | 740 | 0.0740 | 461.9 |
| 10 | 90 | 87.54 | 77.47 | 560 | 0.0560 | 445.6 |
| 25 | 75 | 86.2 | 67.56 | 420 | 0.0420 | 424.2 |

The results of Table 2 confirm that as the amount of the monomer having a cyclohexyl moiety is increased, the Rth may be slightly reduced, but at the same time, the decomposition temperature of 0.5% weight loss is significantly decreased.

### Comparative Example 18

80 mL of N-methylpyrrolidone is added to a 250 mL reactor. 2,2′-bis(trifluoromethyl)benzidine (TFDB) and 9,9-bis(4-aminophenyl)fluorene (BAPF) are added to the reactor in an amount set forth in Table 3, and completely dissolved therein to prepare a diamine solution. 6.6463 g (0.0226 mol) of 3,3′,4,4′-biphenyltetracarboxylic acid dianhydride (BPDA) and 1.2318 g (0.0056 mol) of pyromellitic dianhydride (PMDA) are quickly added to the diamine solution and stirred at room temperature for 48 hours to obtain a solution of the polyamic acid copolymer as a product of condensation polymerization.

The obtained solution is spin-coated to form a film, which is then first-dried on a hot plate at 80° C. for 30 minutes. The dried-film is placed in a furnace and is heated from room temperature to about 300° C. at a heating rate of 10° C./min to obtain a polyimide film.

For the polyimide film, the out-of-plane retardation and the birefringence are measured in the same manner as Example 1, and the results are compiled in Table 3.

For the polyimide film, the light transmittance is measured using a spectroscopic colorimeter (CM-3600D) and the results are compiled in Table 3.

For the heat-treated polyimide film, a thermogravimetric analysis is conducted using a thermogravimetric analyzer (TA TGA Q500) at a heating rate of 10-30° C./min under a nitrogen purge to measure the decomposition temperature of 0.5% weight loss. The results are compiled in Table 3.

TABLE 3

| | | | | | | Td @ |
|---|---|---|---|---|---|---|
| | | | | Rth @ | | 0.5 wt % |
| BAPF | TFDB | Transmittance(%) | | 10 μm | Birefrin- | weight |
| (mol %) | (mol %) | Total | 430 nm | (nm) | gence | loss (he |
| 0 | 100 | 86.61 | 79.96 | 1222 | 0.1222 | 452.2 |
| 1 | 99 | 87.47 | 80.91 | 818 | 0.0818 | 487.2 |
| 5 | 95 | 87.59 | 78.48 | 707 | 0.0707 | 487.6 |
| 10 | 90 | 87.25 | 74.64 | 516 | 0.0516 | 393.9 |

The results of Table 3 confirm that as the amount of the monomer having a fluorenyl moiety is increased, the Rth may be slightly reduced, but at the same time, the decomposition temperature of 0.5% weight loss is significantly decreased.

While this disclosure has been described in connection with what is presently considered to be practical exemplary embodiments, it is to be understood that the invention is not limited to the disclosed embodiments, but, on the contrary, is intended to cover various modifications and equivalent arrangements which are included within the spirit and scope of the appended claims.

What is claimed is:

1. A method of producing a polyimide film, comprising:
obtaining a polyamic acid comprising a repeating unit of Chemical Formula 1: 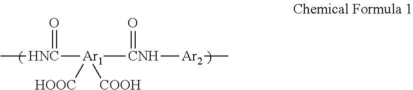
wherein Ar₁ is a moiety selected from a substituted or unsubstituted tetravalent C5 to C24 aliphatic cyclic group, a substituted or unsubstituted tetravalent C6 to C24 aromatic cyclic group, and a substituted or unsubstituted tetravalent C6 to C24 heteroaromatic cyclic group, wherein the aliphatic cyclic group, the aromatic cyclic group, or the heteroaromatic cyclic group is present alone, at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 alkylene group comprising at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof,
Ar₂ is a moiety selected from a substituted or unsubstituted divalent C5 to C24 aliphatic cyclic group, a substituted or unsubstituted divalent C6 to C24 aromatic cyclic group, and a substituted or unsubstituted divalent C4 to C24 heteroaromatic cyclic group, and -L-SiR₂—O—SiR₂-L- (wherein L is a single bond or a C1 to C10 alkylene group), wherein the aliphatic cyclic group or a heteroaromatic cyclic group is present alone, or at least two groups selected from the aliphatic cyclic group and the heteroaromatic cyclic group are fused to form a polycyclic aromatic ring, or at least two groups selected from the aliphatic cyclic group and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 divalent alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof, and
wherein at least one of Ar₁ and Ar₂ comprises an aromatic or aliphatic ring substituted with at least one C1 to C10 fluoroalkyl group, two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group, or a combination thereof;
imidizing the polyamic acid to obtain a partially imidized polyimide;
determining a sub-Tg temperature of the partially imidized polyimide; and
heating the partially imidized polyimide in at least two steps to obtain a polyimide film, wherein a step transition temperature range comprises a temperature within the sub-Tg temperature±30° C.

2. The method according to claim 1, wherein the heat-treating comprises a first heat-treating step and a second heat-treating step directly following the first heat-treating step, and wherein in the first heat-treating step, the final temperature (T1_{final}) is less than the sub-Tg temperature+30° C., and in the second heat-treating step, the initial temperature (T2ᵢₙᵢₜᵢₐₗ) is greater than the sub-Tg temperature+30° C.

3. The method according to claim 1, wherein Ar₁ is selected from groups: 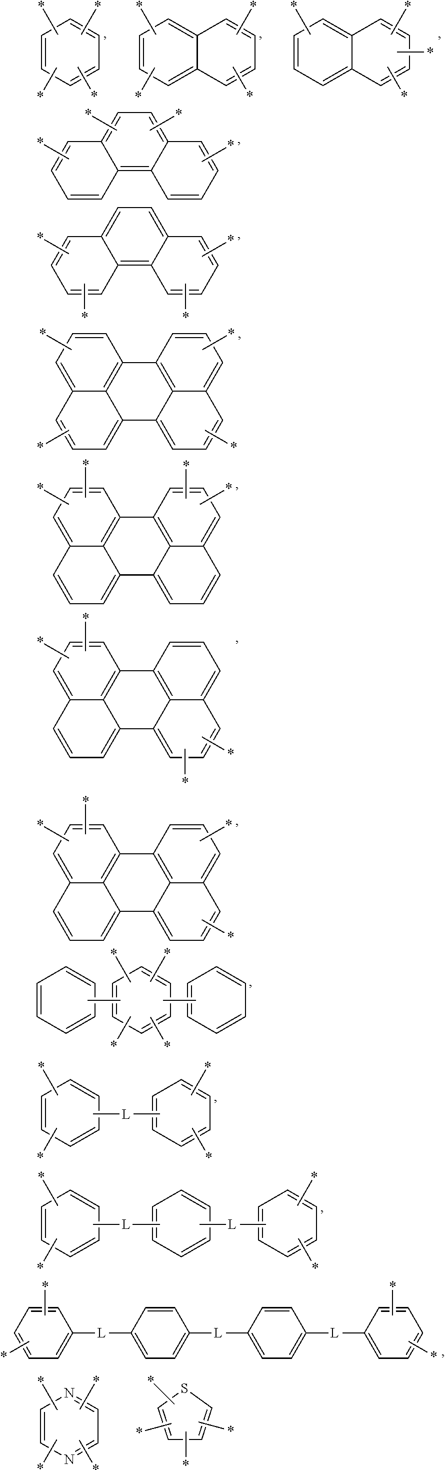
wherein, linkers L are is the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—,
an aromatic ring in the groups is not substituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and
* indicates a binding site to a carbon atom of the carbonyl in an imide ring.

4. The method according to claim 1, wherein Ar₂ is selected from groups: 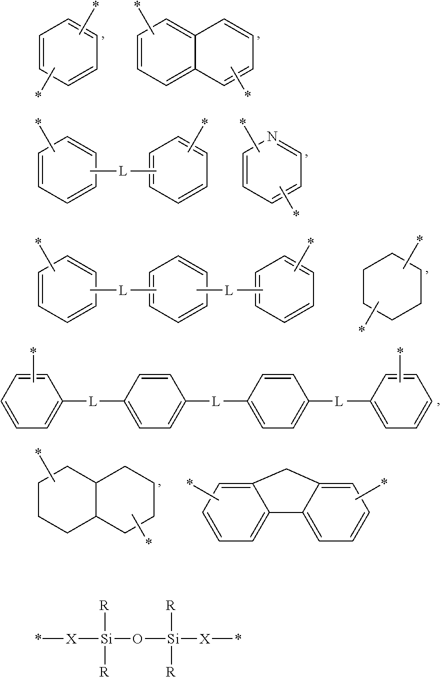
wherein, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents Rare not simultaneously hydrogen), —C(CF₃)₂—, —C(CF₃)(C₆H₅)—, or —C(═O)NH—,
linkers X are the same or different and are each independently a substituted or unsubstituted C1 to C10 alkylene group, a substituted or unsubstituted C4 to C20 cycloalkylene group, or a substituted or unsubstituted C6 to C20 arylene group,
an aromatic or alicyclic ring in the groups is not substituted or at least one hydrogen of the aromatic or alicyclic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and
* indicates a binding site to a nitrogen atom of an imide ring.

5. The method according to claim 1, wherein Ar₁ is represented by chemical formula: 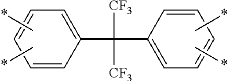
wherein * indicates a binding site to a carbon atom of the carbonyl in an imide ring, and
each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

6. The composition according to claim 1, wherein Ar₂ is represented by chemical formula: 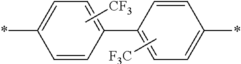
wherein * indicates a binding site to a nitrogen atom of an imide ring,
each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

7. The method according to claim 1, wherein the imidization is chemical imidization.

8. The method according to claim 1, wherein the partially imidized polyimide has a degree of imidization of less than 100%.

9. The method according to claim 1, wherein the sub-Tg temperature of the partially imidized polyimide is determined at the first tan δ peak of a curve obtained by conducting a dynamic mechanical analysis of the partially imidized polyimide as a film containing a residual solvent in an amount of at least about 10% by weight.

10. The method according to claim 1, wherein the sub-Tg temperature of the partially imidized polyimide is within a range of about 100° C. to about 250° C.

11. The method according to claim 1, wherein the polyimide film has birefringence (Δn) defined by Equation 1 of less than or equal to about 0.025, and wherein in a thermogravimetric analysis, a decomposition temperature of 0.5 percent by weight loss of the polyimide film is greater than or equal to about 420° C.:
Δn=(nₓ+n_{y})/2−n_{z} Equation 1
wherein in Equation 1, nₓ and n_{y} are in-plane refractivities and n_{z} is out-of-plane refractivity.

12. A polyimide film comprising a repeating unit represented by Chemical Formula 2: 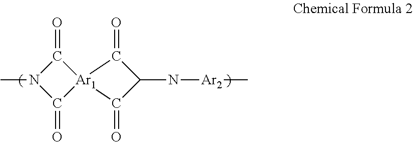
wherein Ar₁ is a moiety selected from a substituted or unsubstituted tetravalent C5 to C24 aliphatic cyclic group, a substituted or unsubstituted tetravalent C6 to C24 aromatic cyclic group, and a substituted or unsubstituted tetravalent C6 to C24 heteroaromatic cyclic group, wherein the aliphatic or aromatic or heteroaromatic cyclic group is present alone, or at least two groups selected from the aliphatic cyclic group, the aromatic cyclic group, and the heteroaromatic cyclic group are fused to form a polycyclic aromatic ring, or at least two groups selected from the aliphatic cyclic group, the aromatic cyclic group, and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof,
Ar₂ is a moiety selected from a substituted or unsubstituted divalent C5 to C24 aliphatic cyclic group, a substituted or unsubstituted divalent C6 to C24 aromatic cyclic group, and a substituted or unsubstituted divalent C4 to C24 heteroaromatic cyclic group, and -L-SiR₂—O—SiR₂-L- (wherein L is a single bond or a C1 to C10 alkylene group), wherein the aliphatic cyclic group or a heteroaromatic cyclic group is present alone, or at least two groups selected from the aliphatic cyclic group and the heteroaromatic cyclic group are fused to form a polycyclic aromatic ring, or at least two groups selected from the aliphatic cyclic group and the heteroaromatic cyclic group are linked by a single bond, O, S, C(═O), S(═O)₂, Si(CH₃)₂, (CH₂)ₚ (wherein 1≦p≦10), (CF₂)_{q} (wherein 1≦q≦10), a C1 to C10 divalent alkylene group having at least one substituent selected from a C1 to C10 straight or branched aliphatic hydrocarbyl group, a C1 to C10 fluoroalkyl group, a C6 to C20 aromatic hydrocarbyl group, and a C6 to C20 alicyclic hydrocarbyl group, C(═O)NH, or a combination thereof, and
wherein at least one of Ar₁ and Ar₂ comprises an aromatic or aliphatic ring substituted with at least one C1 to C10 fluoroalkyl group, two aromatic or aliphatic rings linked by a C1 to C10 alkylene group having at least one substituent selected from a C1 to C10 fluoroalkyl group, a C6 to C20 aromatic hydrocarbyl group, and a C6 to C20 alicyclic hydrocarbyl group; or a combination thereof, and
wherein the birefringence of the film (Δn) defined by Equation 1 is less than or equal to about 0.025 and its 0.5 percent by weight loss decomposition temperature is greater than or equal to about 420° C. in thermogravimetric analysis:
Δn=(nₓ+n_{y})/2−n_{z} Equation 1
wherein nₓ and n_{y} are in-plane refractivity and n_{z} is out-of-plane refractivity.

13. The polyimide film of claim 12, wherein Ar₁ may be selected from groups: 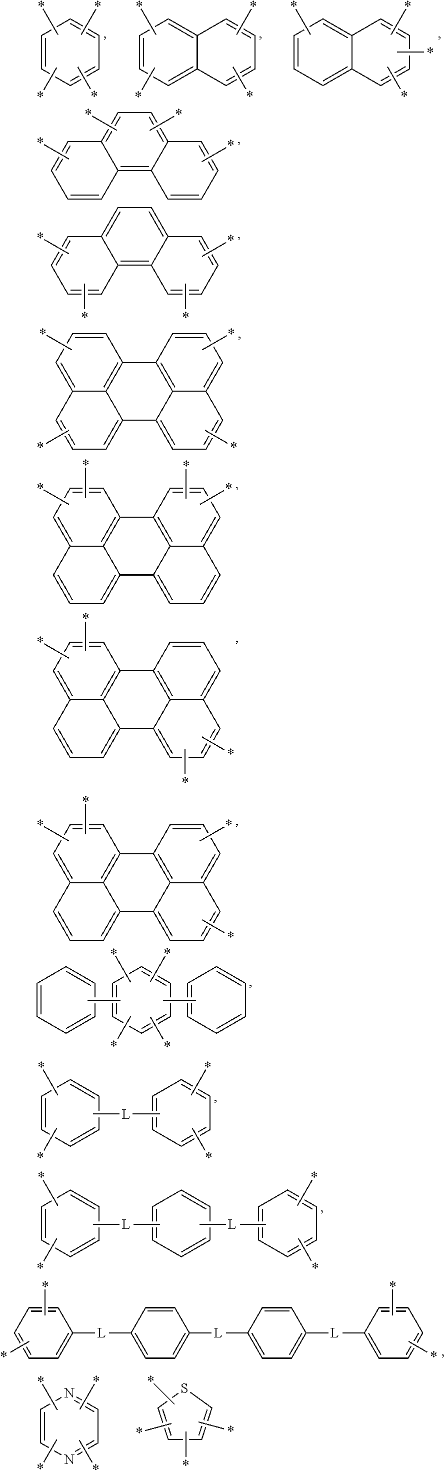
wherein, linkers L are is the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—, and
an aromatic ring in the groups is not substituted or at least one hydrogen of the aromatic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and
* indicates a binding site to a carbon atom of the carbonyl in an imide ring

14. The polyimide film of claim 12, wherein Ar₂ is selected from groups: 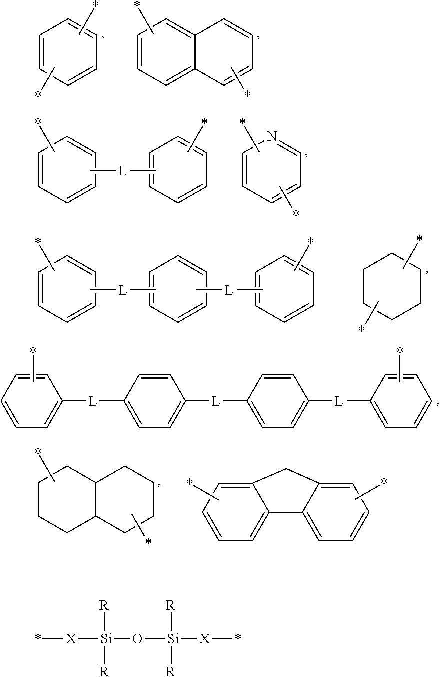
wherein, linkers L are the same or different and are each independently a single bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein substituents R are the same or different and are each independently hydrogen, a C1 to C10 straight or branched aliphatic hydrocarbon group, a C6 to C20 aromatic hydrocarbon group, or a C6 to C20 alicyclic hydrocarbon group, provided that two substituents R are not simultaneously hydrogen), —C(CF₃)₂—, —C(CF₃)(C₆H₅)—, or —C(═O)NH—,
linkers X are the same or different and are each independently a substituted or unsubstituted C1 to C10 alkylene group, a substituted or unsubstituted C4 to C20 cycloalkylene group, or a substituted or unsubstituted C6 to C20 arylene group,
an aromatic or alicyclic ring in the groups is not substituted or at least one hydrogen of the aromatic or alicyclic ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof, and
* indicates a binding site to a nitrogen atom of an imide ring.

15. The polyimide film according to claim 12, wherein Ar₁ is represented by chemical formula: 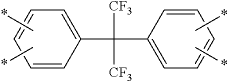
wherein * indicates a binding site to a carbon atom of the carbonyl in an imide ring, and
each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

16. The polyimide film according to claim 12, wherein Ar₂ is represented by chemical formula: 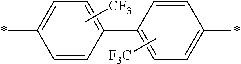
wherein * indicates a binding site to a nitrogen atom of an imide ring,
each aromatic ring is unsubstituted or at least one hydrogen of the ring is substituted with a C1 to C15 alkyl group, —F, —Cl, —Br, —I, a C1 to C15 haloalkyl group, a C1 to C15 alkoxy group, a C6 to C12 aryl group, a C6 to C12 aryloxy group, a nitro group, a hydroxyl group, or a combination thereof.

17. The polyimide film according to claim 12, wherein transmittance of the film is greater than or equal to about 80% with respect to light having a wavelength of 430 nanometers.

18. The polyimide film according to claim 12, wherein the birefringence of the film is less than or equal to about 0.005, and the decomposition temperature of 0.5 percent by weight loss is greater than or equal to about 460° C.

19. The polyimide film according to claim 12, wherein the polyimide comprises at least two repeating units represented by Chemical Formula 1, and wherein the at least two repeating units are different from each other in the Ar₁, the Ar₂, or both.

20. An electronic device comprising a polyimide film of claim 12.
